(19) United States
(12) Patent Application Publication
(10) Pub. No.: US 2019/0111525 A1
(43) Pub. Date: Apr. 18, 2019

(54) ACTUATOR, MOUNT HEAD UNIT, MOUNTING APPARATUS, AND DRIVING METHOD OF ACTUATOR

(71) Applicant: Panasonic Intellectual Property Management Co., Ltd., Osaka (JP)

(72) Inventor: Hiroshi OKAMURA, Osaka (JP)

(21) Appl. No.: 16/159,768

(22) Filed: Oct. 15, 2018

(30) Foreign Application Priority Data
Oct. 16, 2017 (JP) 2017-200670
Oct. 16, 2017 (JP) 2017-200671

(51) Int. Cl. B23K 37/02; H02K 41/02

(52) U.S. Cl. CPC B23K 37/0247; B23Q 5/28; H02K 41/02

(57) ABSTRACT

An actuator includes a rotary motor, a spline member, a linear motor and an output part. The rotary motor includes a rotary mover with a rotational axis, the rotary mover being configured to rotate around the rotational axis. The spline member includes a first member that receives torque from the rotary mover, and a second member. The linear motor includes a linear mover that receives torque from the second member, and a linear stator. The linear mover penetrates the linear stator in a direction of the rotational axis.

### CROSS-REFERENCE TO RELATED APPLICATION

This application is based upon and claims the benefits of priorities of Japanese Patent Application No. 2017-200670 and Japanese Patent Application No. 2017-200671, filed on Oct. 16, 2017, the entire contents of which are incorporated herein by reference.

### TECHNICAL FIELD

This disclosure relates generally to actuators, mount head units, mounting apparatuses and driving methods of actuator, more particularly, to an actuator with a rotary motor and a linear motor, a mount head unit with the actuator, a mounting apparatus with the mount head unit, and a driving method of the actuator.

### BACKGROUND ART

A Document 1 (JPH09-246793 A) discloses an electronic component mounting apparatus that includes: a positioning part of positioning a substrate; and a transfer head of transferring and mounting an electronic component provided in a parts feeder onto the substrate positioned by the positioning part.

In the electronic component mounting apparatus in the Document 1, the transfer head includes a nozzle. An X-axis motor is attached to an upper surface of a bracket. A nut, a nozzle shaft and the nozzle are moved upward or downward along a feed screw driven by the Z-axis motor.

A belt is attached to an output shaft of a θ motor and a pulley attached to the nozzle shaft. Based on driving of the θ motor, the nozzle rotates around its shaft center to correct an angle in a rotational direction of the electronic component vacuum-sucked to a lower end of the nozzle.

In the electronic component mounting apparatus in the Document 1, the feed screw driven by the Z-axis motor, the nozzle shaft, the nozzle and the output shaft of the θ motor are not mutually arranged on the same straight line. For this reason, there has been a problem that an arrangement space for those members is needed to be secured widely in the horizontal direction.

### SUMMARY

The present disclosure is directed to an actuator, a mount head unit, a mounting apparatus and a driving method of the actuator, which can reduce a size in a cross section orthogonal to a direction in which an output part reciprocates.

To solve the above-mentioned problem, an actuator according to an aspect of the present disclosure includes a rotary motor, a spline member, a linear motor, and an output part. The rotary motor includes a rotary mover with a rotational axis (axis line), the rotary mover being configured to rotate around the rotational axis. The spline member includes: a first member that receives torque from the rotary mover to rotate around the rotational axis; and a second member that reciprocates on the rotational axis, and receives torque from the first member to rotate around the rotational axis. The linear motor includes: a linear mover that receives torque from the second member to rotate around the rotational axis; and a linear stator that provides driving force along a direction of the rotational axis to the linear mover. The output part is to be driven by the rotary motor and the linear motor, the output part being disposed at an end of the linear mover. The linear mover penetrates the linear stator in the direction of the rotational axis. The linear mover is configured to rotate around the rotational axis with respect to the linear stator.

To solve the above-mentioned problem, a mount head unit according to an aspect of the present disclosure includes the actuator, and a picking-up part that picks up a first object to be mounted on a second object, the picking-up part being fixed to the output part of the actuator.

To solve the above-mentioned problem, a mounting apparatus according to an aspect of the present disclosure includes the mount head unit, and a holding device that holds the second object.

To solve the above-mentioned problem, a driving method according to an aspect of the present disclosure is a driving method of an actuator. The actuator includes a rotary motor, a spline member, a linear motor and an output part. The rotary motor includes a rotary mover with a rotational axis (axis line), the rotary mover being configured to rotate around the rotational axis. The spline member includes: a first member that receives torque from the rotary mover to rotate around the rotational axis; and a second member that reciprocates on the rotational axis, and receives torque from the first member to rotate around the rotational axis. The linear motor includes: a linear mover that receives torque from the second member to rotate around the rotational axis; and a linear stator that provides driving force along a direction of the rotational axis to the linear mover. The output part is to be driven by the rotary motor and the linear motor, the output part being disposed at an end of the linear mover. The driving method includes: reciprocating, along the direction of the rotational axis, the linear mover penetrating the linear stator in the direction of the rotational axis; and rotating the linear mover around the rotational axis with respect to the linear stator.

### BRIEF DESCRIPTION OF THE DRAWINGS

The figures depict one or more implementations in accordance with the present disclosure, by way of example only, not by way of limitations. In the figures, like reference numerals refer to the same or similar elements.

FIG. 1 is a perspective view of an external appearance of a mounting apparatus according to a First Embodiment.

FIG. 2A is a perspective view of the mounting apparatus in a state where a cover module is removed from the mounting apparatus.

FIG. 2B is a schematic enlarged view of a region Al shown in FIG. 2A.

FIG. 3 is a perspective view of a job module of the mounting apparatus when viewed obliquely from above.

FIG. 4 is a perspective view of the job module when viewed obliquely from below.

FIG. 5A is a principal cross-sectional view of the job module, which cut along a plane orthogonal to a Y-axis direction and passing through a stator of an X-axis linear motor.

FIG. 5B is an enlarged view of a part around the X-axis linear motor shown in FIG. 5A.

FIG. 6A is a principal cross-sectional view of the job module, which cut along a plane orthogonal to an X-axis direction and passing through a stator of a Y-axis linear motor.

FIG. 6B is an enlarged view of a part around the Y-axis linear motor shown in FIG. 6A.

FIG. 7 is a perspective view of a Y-axis moving unit of the job module when viewed obliquely from above.

FIG. 8 is a perspective view of the Y-axis moving unit when viewed obliquely from below.

FIG. 9 is a perspective view of an X-axis moving unit of the job module when viewed obliquely from above.

FIG. 10A is a side view of an actuator, a picking-up unit and a bracket of the job module when viewed from a positive direction of the X-axis.

FIG. 10B is a front view of the actuator, the picking-up unit and the bracket when viewed from a negative direction of the Y-axis.

FIG. 11A is a cross-sectional view of the actuator, which cut along a plane orthogonal to the Y-axis direction.

FIG. 11B is a cross-sectional view of the actuator, which cut along a plane orthogonal to the Z-axis direction.

FIG. 11C is an enlarged view of a part around a linear motor shown in FIG. 11A.

FIG. 12A is a cross-sectional view of the actuator, an output part and the bracket, which cut along a plane orthogonal to the Y-axis direction, in a state where an output unit has risen.

FIG. 12B is a cross-sectional view of the actuator, the output part and the bracket, which cut along a plane orthogonal to the Y-axis direction, in a state where the output unit has fallen.

FIG. 13A is a cross-sectional view of an actuator according to a Second Embodiment, which cut along a plane orthogonal to the Y-axis direction.

FIG. 13B is a cross-sectional view of the actuator of the Second Embodiment, which cut along a plane orthogonal to the Z-axis direction.

FIG. 14A is a cross-sectional view of the actuator, an output part and a bracket according to the Second Embodiment, which cut along a plane orthogonal to the Y-axis direction, in a state where an output unit according to the Second Embodiment has risen to an upper limit position in a movable range.

FIG. 14B is a cross-sectional view of the actuator, the output part and the bracket, which cut along a plane orthogonal to the Y-axis direction, in a state where the output unit has fallen to a lower limit position in the movable range.

FIG. 15A is an enlarged view illustrating a schematic structure of a principal part in FIG. 12A.

FIG. 15B is an enlarged view illustrating a schematic structure of a principal part in FIG. 12B.

FIG. 16A is an enlarged view illustrating a schematic structure of a principal part in FIG. 14A.

FIG. 16B is an enlarged view illustrating a schematic structure of a principal part in FIG. 14B.

FIG. 17A is a schematic cross-sectional view of an actuator, an output part and a bracket according to a Third Embodiment, which cut along a plane orthogonal to the Y-axis direction, in a state where an output unit according to the Third Embodiment has risen to an upper limit position in a movable range.

FIG. 17B is a schematic cross-sectional view of the actuator, the output part and the bracket, which cut along a plane orthogonal to the Y-axis direction, in a state where the output unit has fallen to a lower limit position in the movable range.

FIG. 18A is a schematic cross-sectional view of an actuator, an output part and a bracket according to a Fourth Embodiment, which cut along a plane orthogonal to the Y-axis direction, in a state where an output unit according to the Fourth Embodiment has risen to an upper limit position in a movable range.

FIG. 18B is a schematic cross-sectional view of the actuator, the output part and the bracket, which cut along a plane orthogonal to the Y-axis direction, in a state where the output unit has fallen to a lower limit position in the movable range.

### DETAILED DESCRIPTION

### First Embodiment

### (1) Outline

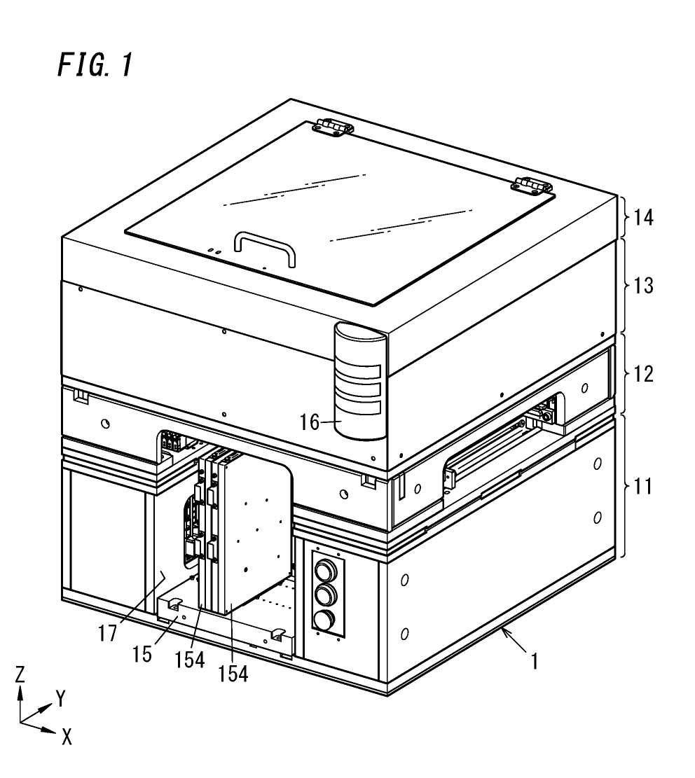

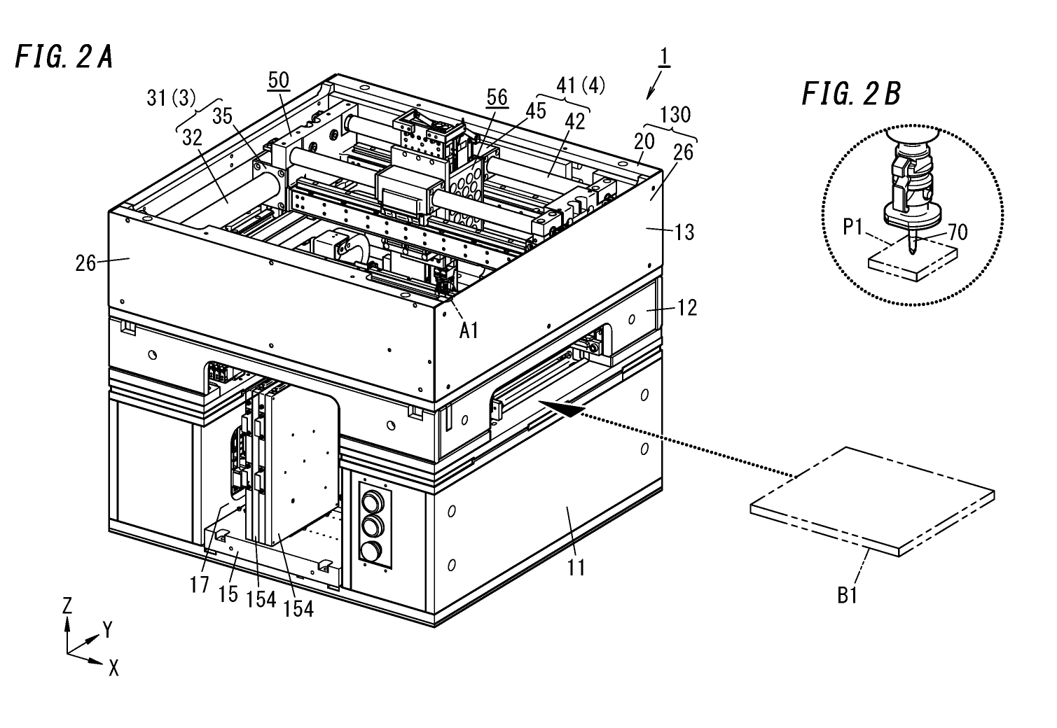

An outline of a manufacturing-job apparatus 1 according to the present embodiment will be explained with reference to FIGS. 1 to 2B. FIG. 2A is a perspective view of the manufacturing job apparatus 1 in a state where a cover module 14 (refer to FIG. 1) described later is removed from the manufacturing job apparatus 1. FIG. 2B is a schematic enlarged view of a region Al shown in FIG. 2A. To the manufacturing job apparatus 1, connected may be a pipe for circulating cooling water, a cable for supplying electric power, a pipe for supplying pneumatic pressure (positive pressure or vacuum) and so on, although those illustrations are appropriately omitted.

The manufacturing job apparatus 1 may be used for manufacturing job of various products (such as an electronic device, car, clothing, food, medicine and crafted product) in facilities (e.g., a factory, research laboratory, office, store, educational institution and the like). Examples of the “job” mentioned in this disclosure include various jobs to be executed for job objects in manufacturing of products. More specifically, examples of the “job” may include mounting, coating, printing, pressing, cutting, welding and filming (photographing). The “job object” mentioned in this disclosure is an object to which the job such as processing is subjected by the manufacturing-job apparatus 1. For example, in case of job of mounting a first object on a second object, the second object corresponds to the “job object”.

In the present embodiment, it is as one example explained that the manufacturing job apparatus 1 is used for manufacturing of electronic devices in a factory and it is a mounting apparatus for performing the job of mounting the first object on the second object (job object). A general electronic device includes various circuit blocks such as a power supply circuit and a control circuit. Those circuit blocks are manufactured through, for example, a solder applying process, a mounting process and a soldering process in that order. In the solder applying process, creamy solder is applied (or printed) on a substrate (printed wiring board). In the mounting process, a component(s) (electronic component(s)) is mounted on the substrate. In the soldering process, the substrate with the component is heated in a reflow furnace to melt the creamy solder, thereby the soldering being performed. The manufacturing job apparatus 1 (mounting apparatus), in the mounting process, performs the job of mounting a component P1 (refer to FIG. 2B) as the first object to a substrate B1 (refer to FIG. 2A) as the second object (job object). In the present embodiment, as one example, explained is a case where the manufacturing job apparatus 1 is used for mounting of the component P1 by the Surface Mount Technology (SMT). However, it is not limited to the SMT, but the manufacturing job apparatus 1 may be used for mounting of the component P1 by the Insertion Mount Technology (IMT).

The manufacturing job apparatus 1 according to the present embodiment includes a control module 11, a holding module 12 and a job module 13. The holding module 12 is configured to hold the job object. The job module 13 is configured to execute a job for the job object. The control module 11 has a function of controlling the holding module 12 and the job module 13. That is, the manufacturing-job apparatus 1 includes at least three modules including the control module 11, the holding module 12 and the job module 13, which are modularized by functions. Each of the at least three modules of the manufacturing-job apparatus 1 may be appropriately selected according to functions to be needed for the manufacturing job apparatus 1 from more kinds of modules respectively having functions different from each other.

In the present embodiment, the manufacturing job apparatus 1 performs the job of mounting the component P1 on the substrate B1 as the job object. Accordingly, the holding module 12 has a function of holding the substrate B1. More specifically, the holding module 12 includes a conveyance device that conveys the substrate B1 as the second object from the outside of the manufacturing-job apparatus 1 into an inside space of the manufacturing-job apparatus 1 and then conveys the substrate B1, for which the job has been completed, from the inside space to the outside. The holding module 12 maintains holding the substrate B1 in the inside space of the manufacturing-job apparatus 1 while at least performing the job for the substrate B1 (mounting of the component P1). That is, the holding module 12 corresponds to a holding device that holds the substrate B1 as the second object. The job module 13 executes the job of mounting the component P1 on the substrate B1. That is, the job module 13 is a picking and placing device that picks up the component P1 as the first object, moves the picked-up component P1 onto the substrate B1 and releases the component P1 (cancels the picked-up state) on the substrate B1 to mount the component P1 on the substrate B 1.

In the present embodiment, the control module 11 has a function as a master in the manufacturing-job apparatus 1, and controls the other modules (holding module 12 and job module 13) as slaves. Although described later in detail, the control module 11 includes a communication unit and a common interface. The communication unit is configured to communicate with each of the holding module 12 and the job module 13. The common interface is configured to supply motive power to both of the holding module 12 and the job module 13. The “motive power” mentioned in this disclosure means energy to be needed for operation of the holding module 12 and the job module 13, and includes electric power (AC power or DC power), pneumatic pressure (positive pressure or vacuum), oil pressure, water pressure and so on. In other words, if any module has an electric motor, the electric power which is energy for driving at least the electric motor may be used as the “motive power”. The control module 11 communicate, using the communication unit, with the holding module 12 and the job module 13 and supplies the motive power from the common interface to the holding and job modules 12 and 13 to control the holding and job modules 12 and 13.

The manufacturing job apparatus 1 according to the present embodiment further includes the cover module 14 and a feeder module 15, and a signal lamp 16 (refer to FIG. 1) in addition to the control module 11, the holding module 12 and the job module 13. In the present embodiment, the control module 11 is provided at the bottom (as the lowest stage), and the holding module 12, the job module 13 and the cover module 14 are combined with the control module 11 to be stacked in that order on the control module 11. The feeder module 15 is housed in a recess 17 formed over the control module 11 and the holding module 12.

Although described later in detail, the cover module 14 corresponds to a terminal module that is one of a plurality of modules, which are connected in series to the control module 11. On a supply passage of the motive power, the cover module 14 is provided on most downstream of the plurality of modules. The feeder module 15 is configured to feed the first object (component P1) to the job module 13. That is, the job module 13 receives the component P1 fed by the feeder module 15, and then mounts the component P1 on the substrate B1 held by the holding module 12. The signal lamp 16 is attached to the cover module 14. The signal lamp 16 changes its display mode (e.g., its light emission color) according to an operation state of the manufacturing job apparatus 1 to visualize the operation state.

### (2) Details

Hereinafter, the manufacturing job apparatus 1 according to the present embodiment will be explained mainly with reference to FIGS. 1 to 2B.

In the following explanations, a direction in which the substrate B1 (as the job object) is conveyed in the inside space of the manufacturing job apparatus 1 is defined as an “X-axis direction”. Also, a direction orthogonal to the X-axis direction in a horizontal plane is defined as a “Y-axis direction”. Furthermore, a direction along a vertical direction is defined as a “Z-axis direction”. In short, the X-axis, Y-axis and Z-axis directions are orthogonal to one another. In case of distinguishing a positive direction of the Z-axis from a negative direction of the Z-axis, the positive and negative directions of the Z-axis are respectively defined as “upward” and “downward” based on a direction of an arrow shown in FIG. 1. Similarly, in case of distinguishing a positive direction of the X-axis from a negative direction of the X-axis, the positive and negative directions of the X-axis are respectively defined as “rightward” and “leftward”. Also, in case of distinguishing a positive direction of the Y-axis from a negative direction of the Y-axis, the positive and negative directions of the Y-axis are respectively defined as “backward” and “forward”. Arrows of the “X-axis”, “Y-axis” and “Z-axis” θ directions in some drawings are illustrated merely for convenience of explanation, and have no entity. The purpose of the directions defined above is not to restrict a use form of the manufacturing job apparatus 1 (direction on use). For example, the manufacturing job apparatus 1 may be used in a state where the X-axis and Y-axis directions are slightly inclined with respect to the horizontal plane.

As described above, the manufacturing job apparatus 1 according to the present embodiment includes the control module 11, the holding module 12, the job module 13, the cover module 14, the feeder module 15 and the signal lamp 16.

Regarding the control module 11, the holding module 12, the job module 13 and the cover module 14, the control module 11 is disposed as the lowest stage, and the holding module 12, the job module 13 and the cover module 14 are stacked in that order in the Z-axis direction. The recess 17 is disposed in front faces of the control module 11 and the holding module 12, and formed over the control module 11 and the holding module 12. The recess 17 is opened forward. The feeder module 15 is housed in the recess 17. The signal lamp 16 is fixed on front faces of the job module 13 and the cover module 14 over a border therebetween.

As shown in FIG. 2A, the manufacturing-job apparatus 1 is configured so that the cover module 14 can be physically separated (removed) from the job module 13. The example of FIG. 2A illustrates a state where the cover module 14 together with the signal lamp 16 is removed. The control module 11, the holding module 12, the job module 13 and the feeder module 15 can be physically separated. That is, the manufacturing job apparatus 1 is configured by combining the plurality of modules (five modules herein) of the control module 11, the holding module 12, the job module 13, the cover module 14 and the feeder module 15, which can be physically separated. The plurality of modules are coupled with each other by fasteners such as screws.

As shown in FIG. 1, in a state where the plurality of modules are combined, the manufacturing job apparatus 1 can be treated as a single apparatus in which the plurality of modules are integrated. In this state, the manufacturing job apparatus 1 has, for example, an approximate cubic shape, where dimensions thereof in three axis directions of the X-axis, Y-axis and Z-axis directions are substantially equal to each other. The dimension of each side of the cubic shape is, as one example, set to be more than or equal to 500mm, but less than or equal to 1000mm, more preferably, substantially equal to 600mm. By setting to such dimensions, the manufacturing job apparatus 1 can be used as a desk top type of apparatus, and can be therefore easily installed not only in a factory but also in other facilities (e.g., a research laboratory, office, store, educational institution and the like). Also another apparatus can be placed in an empty space generated above the manufacturing-job apparatus 1, when viewed from the manufacturing-job apparatus 1, for example.

The manufacturing job apparatus 1 is configured so that the control module 11 is bidirectionally communicatable with each of the holding module 12, the job module 13 and the feeder module 15. Accordingly, the plurality of modules, which can be physically separated, are linked to operate as the single manufacturing-job apparatus 1. The manufacturing-job apparatus 1 is further configured to communicate, through the control module 11, with various installation apparatuses, communication terminals or the like other than the manufacturing-job apparatus 1.

The manufacturing-job apparatus 1 is connected, via the control module 11, to all of an electric power source, a positive pressure source and a vacuum source, which are supply sources of the motive power. In other words, the manufacturing-job apparatus 1 is configured so that the control module 11 acquires the motive power for each module once and then distributes the motive power to the modules other than the control module 11.

Herein, the holding module 12 and the job module 13 of the present embodiment are connected, in series to the control module 11, on a supply passage through which the motive power is supplied from the common interface of the control module 11. That is, when focused on the supply passage of the motive power, the holding module 12 and the job module 13 have a relationship of a series-connection with respect to the control module 11. Therefore, the motive power for the holding module 12 is supplied from the control module 11 directly to the holding module 12, and the motive power for the job module 13 is supplied from the control module 11 to the job module 13 through the holding module 12.

According to the above-mentioned configuration, since the control module 11 includes the common interface, the motive power can be supplied from the control module 11 with respect to various kinds of modules, as long as the kinds of modules are the holding module 12 and the job module 13 conforming to the common interface. Furthermore since the control module 11 includes the communication unit that communicates with each of the holding module 12 and the job module 13, it is possible to combine various kinds of modules, as long as the kinds of modules are the holding module 12 and the job module 13 having a function for communication with the communication unit. Thus, in the manufacturing-job apparatus 1 according to the present embodiment, various kinds of holding modules 12 and job modules 13 can be selectively coupled (combined) to the control module 11.

For example when the common interface has an aspect capable of supplying, as the motive power, both of the electric power and the pneumatic pressure, the combination can be realized with even any of: the holding module 12 or job module 13 to be operated with the electric power; and the holding module 12 or job module 13 to be operated with the pneumatic pressure. In other words, even in case connecting the holding module 12 and the job module 13, which are operated with only the electric power, the motive power can be supplied to the holding module 12 and the job module 13, depending on the control module 11 including the common interface applicable to both of the electric power and the pneumatic pressure. Also the holding module 12 and the job module 13, which are operated with only the pneumatic pressure, can be combined with the control module 11.

As a result, the holding module 12 and the job module 13 to be combined with the control module 11 can be selected from various kinds of holding modules 12 and job modules 13, and the manufacturing-job apparatus 1 is easily changeable in nature, quality and the like of an executable job. That is, changing the holding module 12 or the job module 13 to be combined with the control module 11 can easily change in nature, quality and the like of an executable job, as the manufacturing-job apparatus 1.

Hereinafter, the job module 13 is explained in detail. In the following explanations, the manufacturing job apparatus 1 is assumed as a mounting apparatus 1.

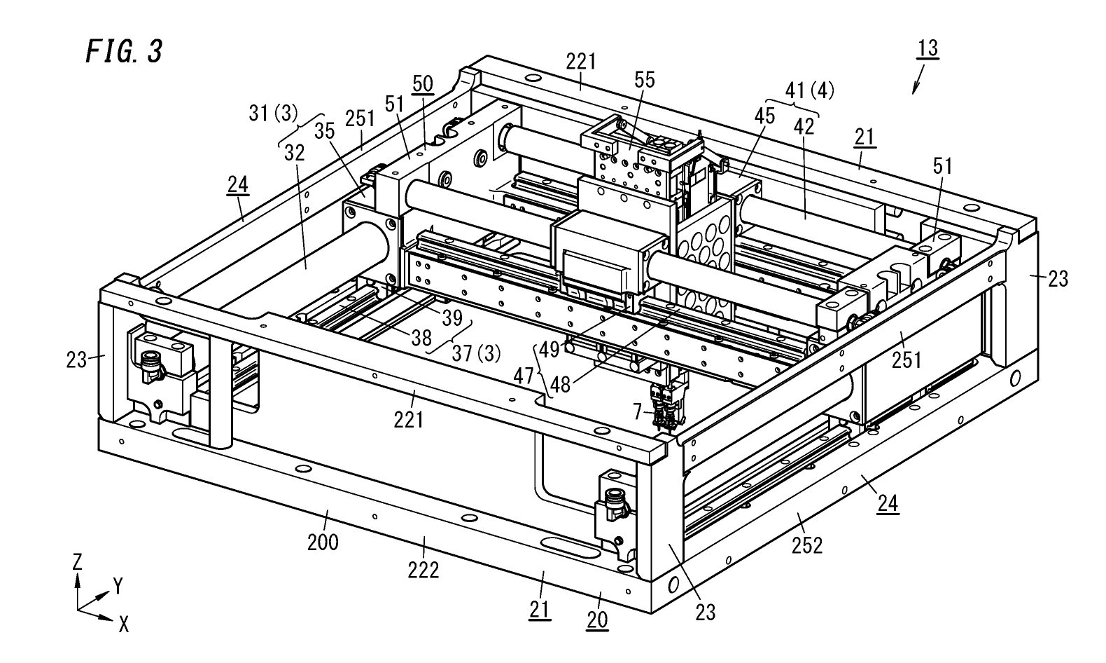

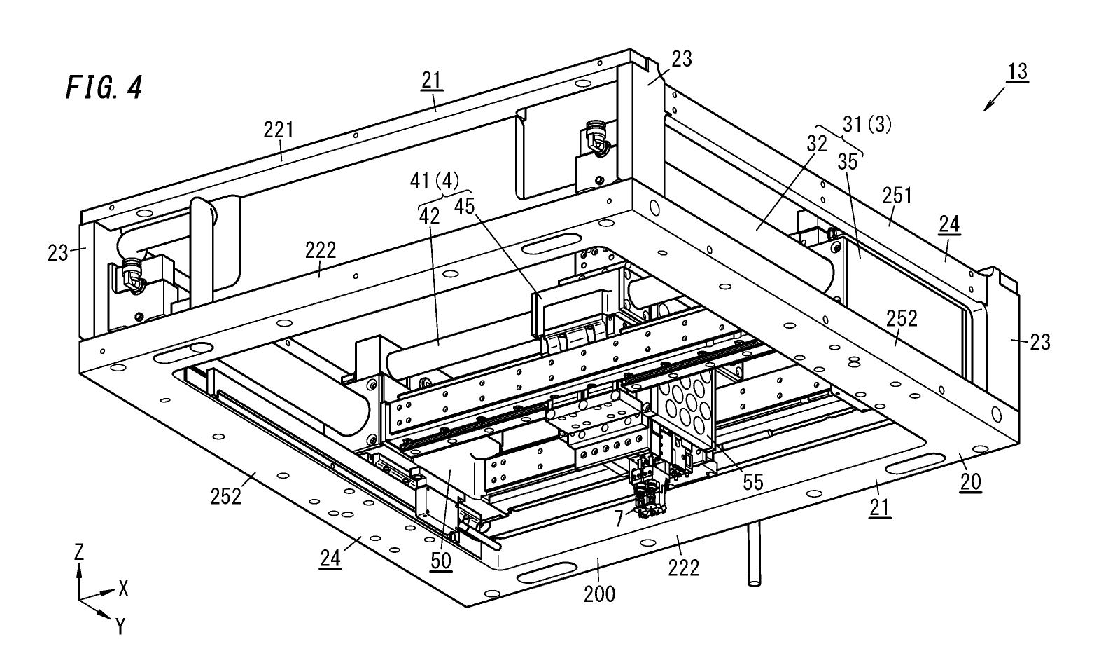

As shown in FIGS. 3 and 4, the job module 13 includes a job module frame 20. The job module frame 20 includes a bottom frame 200 with a rectangular shape each side of which is along the X-axis direction or the Y-axis direction. The bottom frame 200 includes a pair of X-axis beam parts 222 and a pair of Y-axis beam parts 252. The paired X-axis beam parts 222 are respectively positioned at front and back ends of the bottom frame 200. The paired Y-axis beam parts 252 are respectively positioned at right and left ends of the bottom frame 200. An upper side X-axis beam part 221 is positioned above each X-axis beam part 222. An upper side Y-axis beam part 251 is positioned above each Y-axis beam part 252. The X-axis beam parts 221 and 222 are connected to each other with connection pieces 23 at both ends of the X-axis and Y-axis beam parts 221 and 222 in the X-axis direction. The X-axis beam parts 221 and 222 and the connection pieces 23 constitute an X-axis beam 21. The Y-axis beam parts 251 and 252 and the connection pieces 23 constitute a Y-axis beam 24. The connection pieces 23 are shared by the X-axis beams 21 and the Y-axis beams 24.

The X-axis beams 21 and the Y-axis beams 24 constitute the job module frame 20 with prescribed flexural rigidity. As shown FIG. 2A, the job module frame 20 is provided with a cover 26 attached thereto. The job module frame 20 and the cover 26 constitute a casing 130 of the job module 13.

As shown in FIGS. 3 and 4, the job module 13 further includes a Y-axis moving device 3 and an X-axis moving device 4. The Y-axis moving device 3 includes a Y-axis linear motor(s) 31 that is a so-called “cylindrical linear motor”.

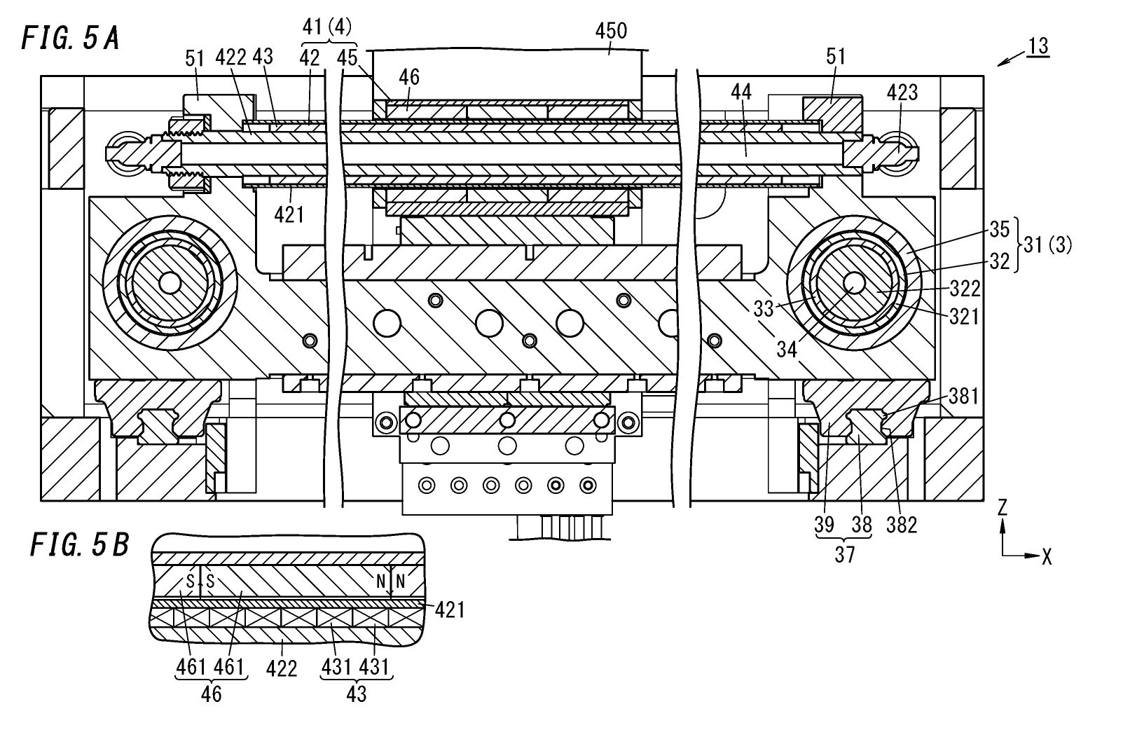

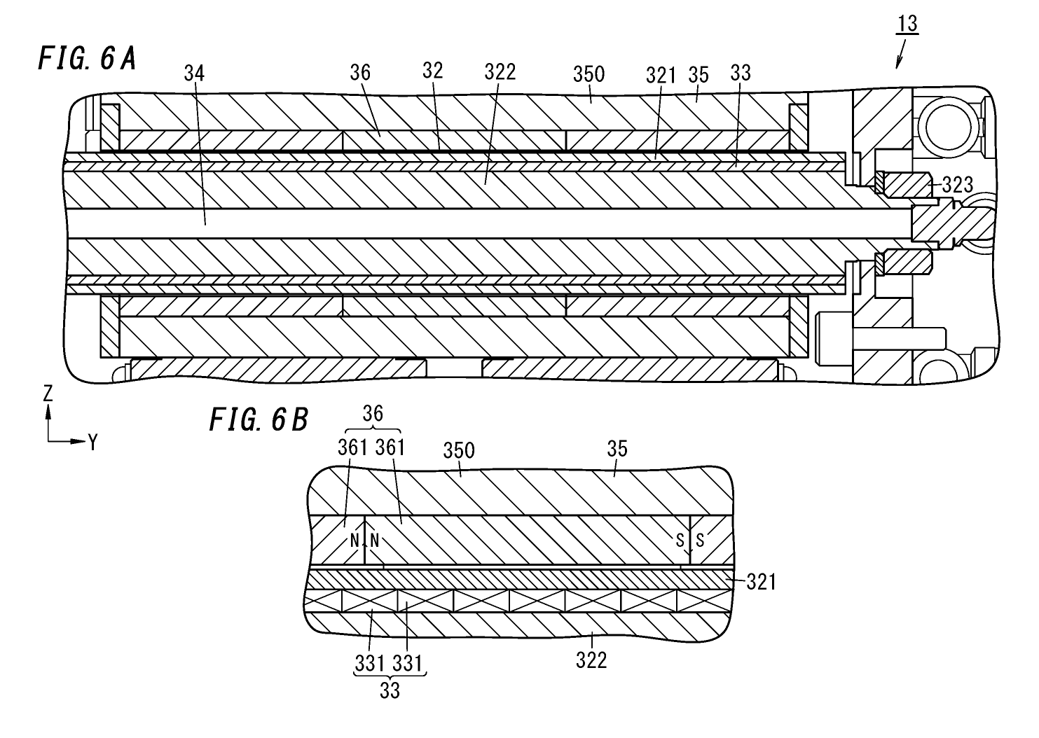

The Y-axis linear motor 31 includes a Y-axis linear motor stator 32 and a Y-axis linear motor mover 35. As shown in FIG. 5A, the Y-axis linear motor stator 32 includes: an outer cylinder 321 with an axis (axis line), a direction (longitudinal direction) of which is in parallel to the Y-axis direction; and a winding core 322 formed as a tubular member. As shown in FIG. 6A, the winding core 322 is disposed inside of the outer cylinder 321, and has an axis (axis line), a direction of which is in parallel to the Y-axis direction. The winding core 322 is provided with a coil 33 (described later) wound around a surface of the winding core 322 so that the coil 33 is held by the winding core 322. The outer cylinder 321 has both ends in the direction of the axis thereof, the both ends being fixed to the job module frame 20. The winding core 322 penetrates the job module frame 20 in the direction of the axis and is fixed to the job module frame 20.

The Y-axis linear motor stator 32 further has a flow channel for allowing refrigerant to pass therethrough, the flow channel being in the winding core 322 formed as the tubular member. That is, the winding core 322 has an inside space 34 corresponding to the flow channel for the refrigerant (e.g., cooling water). The winding core 322 is provided with a pipe joint 323 which is attached to an end of the winding core 322 in the direction of the axis. To the pipe joint 323, a water supply pipe (such as a hose) is connected to allow the refrigerant to pass through the inside space 34. The inside space 34, the pipe joint 323 and the hose constitute a cooling unit. The coil 33 that is a heat source is cooled by the refrigerant passing through the inside space 34. Note that even in a case the refrigerant does not pass through the inside space 34, heat from the coil 33 would be radiated to e.g., the inside space 34 through the winding core 322 and a cooling effect of the coil 33 would be therefore obtained.

The Y-axis linear motor stators 32 are respectively disposed at both ends of the job module frame 20 in the X-axis direction. That is, the Y-axis moving device 3 includes two Y-axis linear motors 31.

The Y-axis linear motor stator 32 includes the coil 33. As shown in FIG. 6B, the coil 33 is constituted by a plurality of unit coils 331 arranged in the Y-axis direction. As one example, three unit coils 331 (respectively corresponding to a U-phase, a V-phase and a W-phase) are defined as a set and a plurality of the sets are arranged in the Y-axis direction. Each unit coil 331 is wound to the winding core 322 around the Y-axis. The coil 33 and the winding core 322 are housed in the outer cylinder 321 with the coil 33 being wound around the winding core 322.

The Y-axis linear motor mover 35 includes a permanent magnet 36, where magnetic force acts on between the permanent magnet 36 and the coil 33 while excitation current is allowed to flow through the coil 33. The permanent magnet 36 has a cylindrical shape with an axis (axis line), a direction of which is in parallel to the Y-axis direction. The permanent magnet 36 is constituted by a plurality of unit permanent magnets 361 arranged in the Y-axis direction. Each unit permanent magnet 361 has a cylindrical shape with an axis (axis line), a direction of which is in parallel to the Y-axis direction. The unit permanent magnet 361 has an S pole or an N pole at both ends thereof in the Y-axis direction. In the plurality of unit permanent magnets 361, two unit permanent magnets 361 adjacent in the Y-axis direction are arranged so that the poles of ends thereof facing each other are the same (the S poles, or the N poles).

As shown in FIG. 3, the Y-axis linear motor mover 35 covers the Y-axis linear motor stator 32 so as to enclose the Y-axis linear motor stator 32 around the Y-axis. The Y-axis linear motor mover 35 has a length in the Y-axis direction shorter than that of the Y-axis linear motor stator 32 in the Y-axis direction. The Y-axis linear motor mover 35 is straightly movable in the Y-axis direction along the Y-axis linear motor stator 32. The permanent magnet 36 receives a magnetic flux generated by the coil 33 in the state where the excitation current is allowed to flow. Driving force for straightly moving the Y-axis linear motor mover 35 in the Y-axis direction is generated due to the reception of the magnetic flux.

The Y-axis linear motor mover 35 is housed in a Y-axis moving unit 50 described later.

The Y-axis moving device 3 further includes a Y-axis linear guide 37. As shown in FIG. 5A, the Y-axis linear guide 37 is a so-call LM (Linear Motion) guide (registered trademark), which includes a Y-axis linear guide rail 38 and a Y-axis linear guide slider 39. The Y-axis linear guide rail 38 is fixed to an upper surface of the corresponding X-axis beam part 222 of the job module frame 20 so that the longitudinal direction of the Y-axis linear guide rail 38 is in parallel to the Y-axis direction. The Y-axis linear guide rails 38 are respectively provided at both ends of the job module frame 20 in the X-axis direction. In other words, the Y-axis moving device 3 includes two Y-axis linear guides 37.

The Y-axis linear guide rail 38 has a constant shape even in any cross sections which cut along planes orthogonal to the Y-axis direction, regardless of positions in the X-axis direction. The Y-axis linear guide rail 38 includes: an intermediate part 382 in the vertical direction; and an upper part 381 provided above the intermediate part 382. The intermediate part 382 has a width (i.e., a length in the X-axis direction) shorter than that of the upper part 381.

The Y-axis linear guide slider 39 is fitted into the Y-axis linear guide rail 38. In a cross section cut along a plane orthogonal to the Y-axis direction, the Y-axis linear guide slider 39 has a shape corresponding to the above-mentioned shape of the Y-axis linear guide rail 38. The Y-axis linear guide slider 39 is therefore fitted substantially without any gap into the Y-axis linear guide rail 38. As mentioned above since, in the cross sections of the Y-axis linear guide rail 38 cut along planes orthogonal to the Y-axis direction, the width of the intermediate part 382 is shorter than the width of the upper part 381 provided above the intermediate part 382, the Y-axis linear guide slider 39 is prevented from dropping out upward from the Y-axis linear guide rail 38.

In the First Embodiment, the Y-axis moving device 3 is constituted by the Y-axis linear motors 31 and the Y-axis linear guides 37.

The Y-axis linear guide 37 is disposed to be separated from the Y-axis linear motor 31.

In particular, the Y-axis linear guide rail 38 is separated from the Y-axis linear motor stator 32. In other words, the Y-axis linear motor mover 35 is positioned around the Y-axis linear motor stator 32. Thus, the Y-axis linear guide rail 38 is disposed to be separated from the Y-axis linear motor stator 32 to avoid interference with the Y-axis linear motor mover 35. The Y-axis linear motor 31 includes the coil 33 as the heat source. Since the Y-axis linear guide 37 is separated from the Y-axis linear motor 31, the Y-axis linear guide 37 is hardly influenced by heat generated from the coil 33. As a result, the Y-axis linear guide 37 is suppressed from changing in dimension thereof due to thermal expansion or thermal shrinkage thereof.

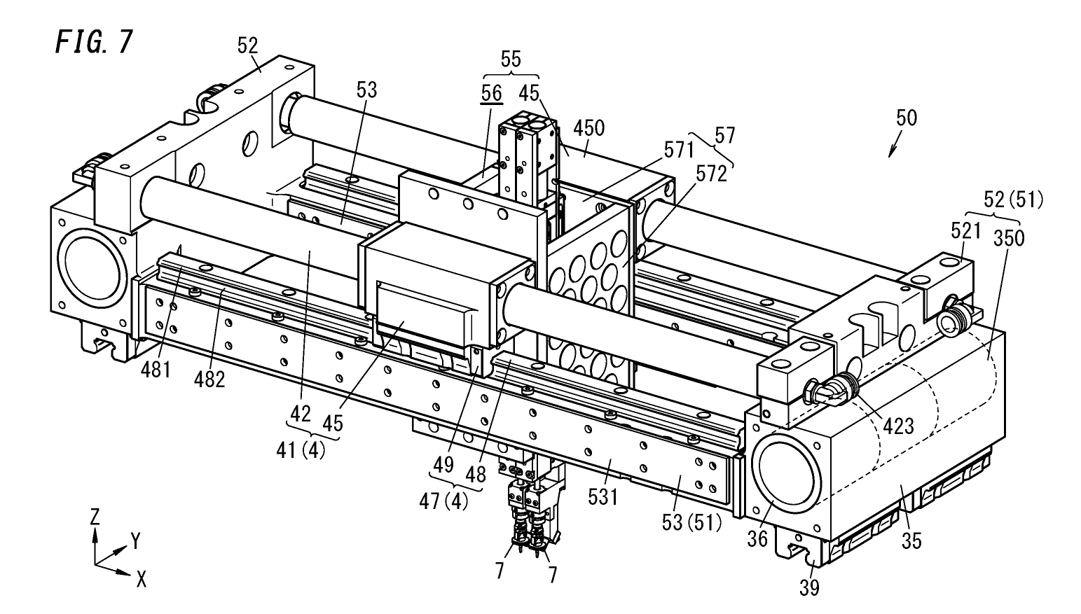

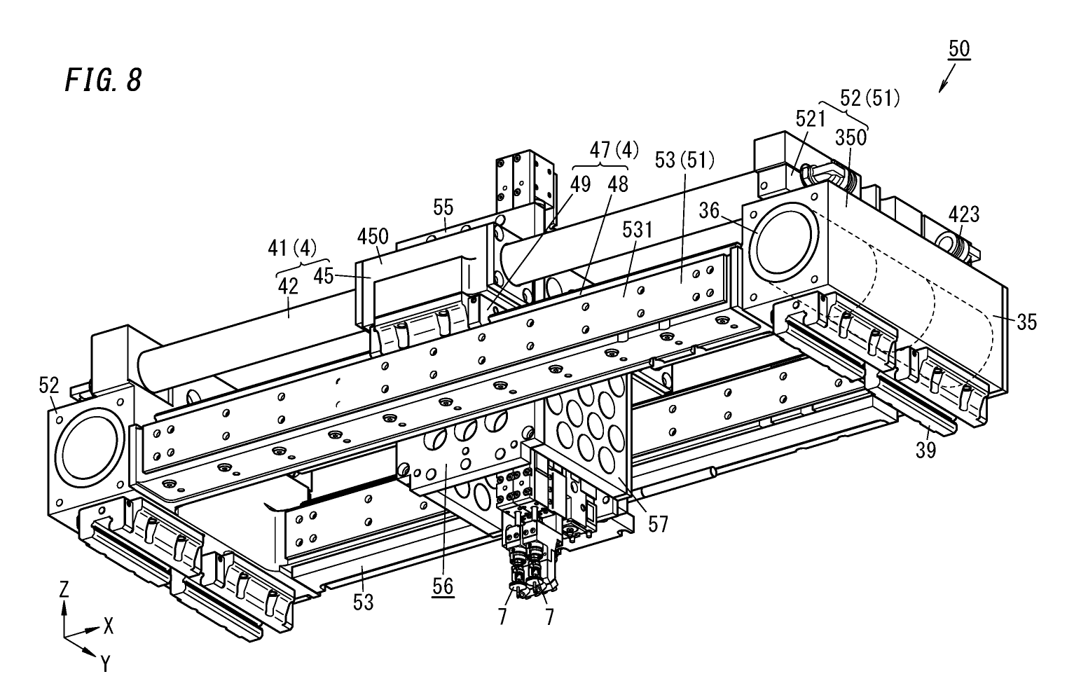

As shown in FIG. 3, the Y-axis moving unit 50 is constituted by a Y-axis moving frame 51 (described below) that is fixed to the Y-axis linear guide slider 39. As shown in FIGS. 7 and 8, the Y-axis moving unit 50 includes the Y-axis linear motor mover 35, and is configured to move straightly in the Y-axis direction. That is, the Y-axis moving unit 50 is guided by the Y-axis linear guide 37 so that the moving locus thereof in the Y-axis direction is linear. The Y-axis moving unit 50 accordingly can obtain, from the Y-axis linear motor 31, the driving force for moving straightly in the Y-axis direction.

The Y-axis moving unit 50 includes the Y-axis moving frame 51 with a rectangular shape in planar view. The Y-axis moving frame 51 includes a Y-axis beam 52, a longitudinal direction of which is in parallel to the Y-axis direction. The Y-axis beam 52 includes a Y-axis beam part 521 and a Y-axis mover casing 350. The Y-axis mover casing 350 is disposed below the Y-axis beam part 521, and fixed thereto. The Y-axis mover casing 350 houses therein the permanent magnet 36 of the Y-axis linear motor mover 35, and together with the permanent magnet 36 constitute the Y-axis linear motor mover 35. The Y-axis beams 52 are respectively provided at both ends of the Y-axis moving frame 51 in the X-axis direction. In other words, the Y-axis moving frame 51 includes two Y-axis beams 52.

The Y-axis moving frame 51 includes an X-axis beam 53, a longitudinal direction of which is in parallel to the X-axis direction. The X-axis beam 53 is constituted by an X-axis beam part 531. The X-axis beams 53 are respectively provided at both ends of the Y-axis moving unit 50 in the Y-axis direction. In other words, the Y-axis moving frame 51 includes two X-axis beams 53.

The Y-axis moving unit 50 includes the X-axis moving device 4. The X-axis moving device 4 is fixed to the Y-axis moving frame 51. The Y-axis moving unit 50 is constituted by the X-axis moving device 4, the Y-axis moving frame 51 and the Y-axis linear guide slider 39.

The X-axis moving device 4 includes an X-axis linear motor(s) 41 that is a so-called “cylindrical linear motor”. The X-axis linear motor 41 includes an X-axis linear motor stator 42 and an X-axis linear motor mover 45. As shown in FIG. 5A, the X-axis linear motor stator 42 includes: an outer cylinder 421 with an axis (axis line), a direction (longitudinal direction) of which is in parallel to the X-axis direction; and a winding core 422 formed as a tubular member. The winding core 422 is disposed inside of the outer cylinder 421, and has an axis (axis line), a direction of which is in parallel to the X-axis direction. The winding core 422 is provided with a coil 43 (described later) wound around a surface of the winding core 422 so that the coil 43 is held by the winding core 422. The outer cylinder 421 has both ends in the direction of the axis thereof, the both ends being fixed to the Y-axis moving frame 51. The winding core 422 penetrates the Y-axis moving frame 51 in the direction of the axis and is fixed to the Y-axis moving frame 51.

The X-axis linear motor stator 42 further has a flow channel for allowing refrigerant to pass therethrough, the flow channel being in the winding core 422 formed as the tubular member. That is, the winding core 422 has an inside space 44 corresponding to the flow channel for the refrigerant (e.g., cooling water). The winding core 422 is provided with a pipe joint 423 which is attached to an end of the winding core 422 in the direction of the axis. To the pipe joint 423, a water supply pipe (such as a hose) is connected to allow the refrigerant to pass through the inside space 44. The inside space 44, the pipe joint 423 and the hose constitute a cooling unit. The coil 43 that is a heat source is cooled by the refrigerant passing through the inside space 44. Note that even in a case the refrigerant does not pass through the inside space 44, heat from the coil 43 would be radiated to e.g., the inside space 44 through the winding core 422 and a cooling effect of the coil 43 would be therefore obtained.

The X-axis linear motor stators 42 are respectively provided at both ends of the Y-axis moving unit 50 in the Y-axis direction. In other words, the Y-axis moving unit 50 includes two X-axis linear motors 41.

The X-axis linear motor stator 42 includes the coil 43. As shown in FIG. 5B, the coil 43 is constituted by a plurality of unit coils 431 arranged in the X-axis direction. As one example, three unit coils 431 (respectively corresponding to a U-phase, a V-phase and a W-phase) are defined as a set and a plurality of the sets are arranged in the X-axis direction. Each unit coil 431 is wound to the winding core 422 around the X-axis. The coil 43 and the winding core 422 are housed in the outer cylinder 421 with the coil 43 being wound around the winding core 422.

The X-axis linear motor mover 45 includes a permanent magnet 46, where magnetic force acts on between the permanent magnet 46 and the coil 43 while excitation current is allowed to flow through the coil 43. The permanent magnet 46 has a cylindrical shape with an axis (axis line), a direction of which is in parallel to the X-axis direction. The permanent magnet 46 is constituted by a plurality of unit permanent magnets 461 arranged in the X-axis direction. Each unit permanent magnet 461 has a cylindrical shape with an axis (axis line), a direction of which is in parallel to the X-axis direction. The unit permanent magnet 461 has an S pole or an N pole at both ends thereof in the X-axis direction. In the plurality of unit permanent magnets 461, two unit permanent magnets 461 adjacent in the X-axis direction are arranged so that the poles of ends thereof facing each other are the same (the S poles, or the N poles). The permanent magnet 46 is housed in an X-axis mover casing 450.

As shown in FIG. 7, the X-axis linear motor mover 45 covers the X-axis linear motor stator 42 so as to enclose the X-axis linear motor stator 42 around the X-axis. The X-axis linear motor mover 45 has a length in the X-axis direction shorter than that of the X-axis linear motor stator 42 in the X-axis direction. The X-axis linear motor mover 45 is straightly movable in the X-axis direction along the X-axis linear motor stator 42. The permanent magnet 46 receives a magnetic flux generated by the coil 43 in the state where the excitation current is allowed to flow. Driving force for straightly moving the X-axis linear motor mover 45 in the X-axis direction is generated due to the reception of the magnetic flux.

The X-axis moving device 4 further includes an X-axis linear guide 47. The X-axis linear guide 47 is a so-call LM (Linear Motion) guide (registered trademark), which includes an X-axis linear guide rail 48 and an X-axis linear guide slider 49. The X-axis linear guide rail 48 is fixed to an upper surface of the corresponding X-axis beam part 531 of the Y-axis moving frame 51 so that the longitudinal direction of the X-axis linear guide rail 48 is in parallel to the X-axis direction. The X-axis linear guide rails 48 are respectively provided at both ends of the Y-axis moving frame 51 in the Y-axis direction. In other words, the X-axis moving device 4 includes two X-axis linear guides 47.

As shown in FIG. 7, the X-axis linear guide rail 48 has a constant shape even in any cross sections which cut along planes orthogonal to the X-axis direction, regardless of positions in the Y-axis direction. The X-axis linear guide rail 48 includes: an intermediate part 482 in the vertical direction; and an upper part 481 provided above the intermediate part 482. The intermediate part 482 has a width (i.e., a length in the Y-axis direction) shorter than that of the upper part 481.

The X-axis linear guide slider 49 is fitted into the X-axis linear guide rail 48. In a cross section cut along a plane orthogonal to the X-axis direction, the X-axis linear guide slider 49 has a shape corresponding to the above-mentioned shape of the X-axis linear guide rail 48. The

X-axis linear guide slider 49 is therefore fitted substantially without any gap into the X-axis linear guide rail 48. As mentioned above since, in the cross sections of the X-axis linear guide rail 48 cut along planes orthogonal to the X-axis direction, the width of the intermediate part 482 is shorter than that of the upper part 481 provided above the intermediate part 482, the X-axis linear guide slider 49 is prevented from dropping out upward from the X-axis linear guide rail 48. In the present embodiment, the X-axis moving device 4 is constituted by the X-axis linear motors 41 and the X-axis linear guides 47.

The X-axis linear guide 47 is disposed to be separated from the X-axis linear motor 41. In particular, the X-axis linear guide rail 48 is separated from the X-axis linear motor stator 42. In other words, the X-axis linear motor mover 45 is positioned around the X-axis linear motor stator 42. Thus, the X-axis linear guide rail 48 is disposed to be separated from the X-axis linear motor stator 42 to avoid interference with the X-axis linear motor mover 45. The X-axis linear motor 41 includes the coil 43 as the heat source. Since the X-axis linear guide 47 is separated from the X-axis linear motor 41, the X-axis linear guide 47 is hardly influenced by heat generated from the coil 43. As a result, the X-axis linear guide 47 is suppressed from changing in dimension thereof due to thermal expansion or thermal shrinkage thereof.

In the present embodiment, X-axis linear guide sliders 49 are provided with a mount head unit 56 fixed thereto. As shown in FIG. 7, the mount head unit 56 and the X-axis linear motor movers 45 constitute an X-axis moving unit 55. The mount head unit 56 moves together with the X-axis linear motor mover 45 straightly in the X-axis direction. That is, the mount head unit 56 is guided by the X-axis linear guide 47 so that the moving locus thereof in the X-axis direction is linear. The mount head unit 56 accordingly can obtain, from the X-axis linear motor 41, the driving force for moving straightly in the X-axis direction.

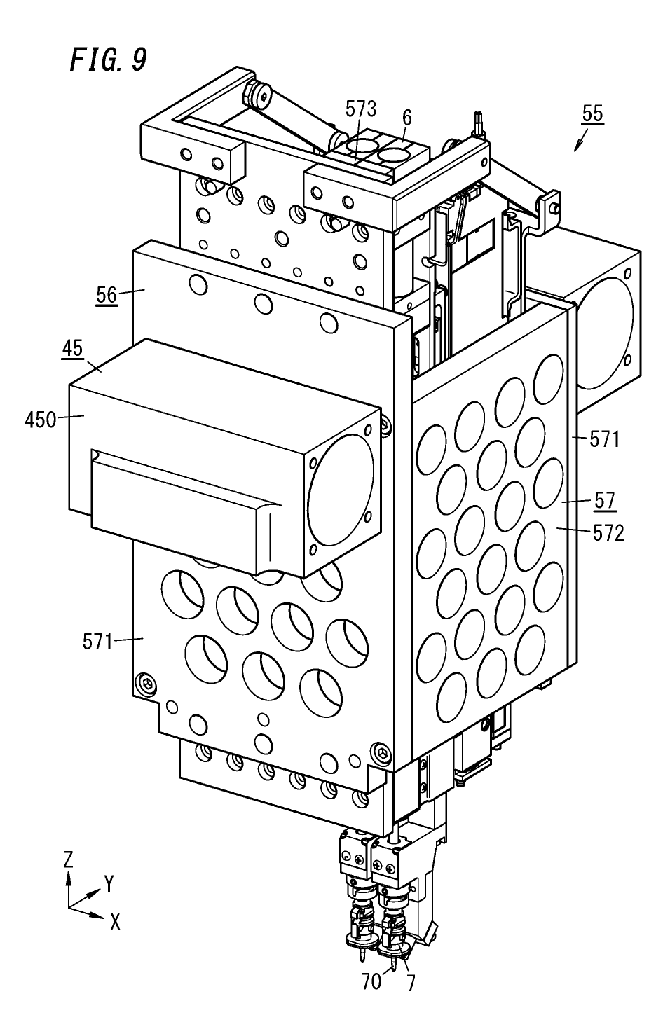

As shown in FIG. 9, the mount head unit 56 includes a mount head frame 57 with a rectangular shape in planar view. The mount head frame 57 includes: two plates 571 respectively fixed to the two X-axis mover casings 450; and two plates 572 coupling the two plates 571. The plate 571 is provided with a bracket 573 fixed thereto. The bracket 573 is to fix an actuator 6 and a picking-up unit 7 (described later). The plates 571 and 572 and the bracket 573 constitute the mount head frame 57.

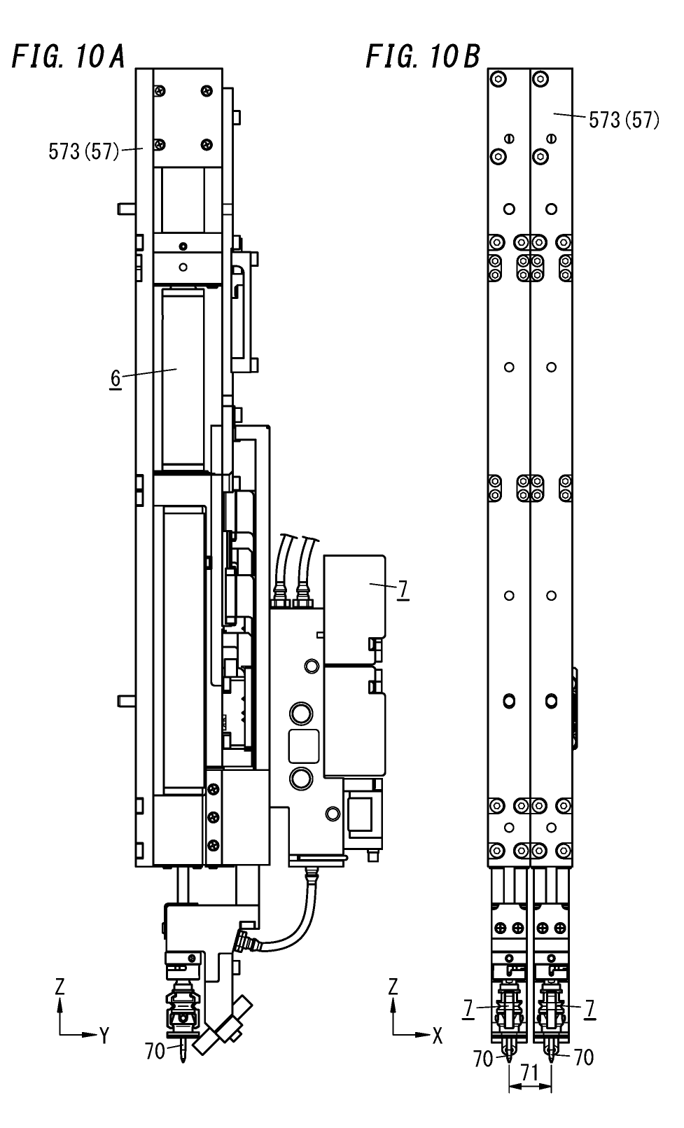

As shown in FIGS. 10A and 10B, to the mount head frame 57, a picking-up part 70 for holding a first object (component P1) is fixed via the actuator 6 (in the example of the drawings, two picking-up parts 70 and two actuators 6). The picking-up part 70 includes a suction nozzle, for example. The picking-up part 70 is switchable between a picking-up state of picking-up (holding) the component P1 and a release state of releasing the component P1 (i.e., cancelling the picking-up). The picking-up part 70 is not limited to the suction nozzle, but may be configured to pick up (hold) the component P1 by putting (clipping) the component P1 between two or more members, as a robot hand. The actuator 6 allows the picking-up part 70 to move linearly in the Z-axis direction. The actuator 6 further allows the picking-up part 70 to rotate in a rotating direction (hereinafter, referred to as a “θ direction”) around an axis (axis line) along the Z-axis direction. The X-axis moving device 4 allows the mount head unit 56 to move linearly in the X-axis direction. The Y-axis moving device 3 allows the mount head unit 56 to move linearly in the Y-axis direction. In this manner, the Y-axis moving device 3 and the X-axis moving device 4 can allow the picking-up part 70 to move in the X-axis, Y-axis, Z-axis and θ directions.

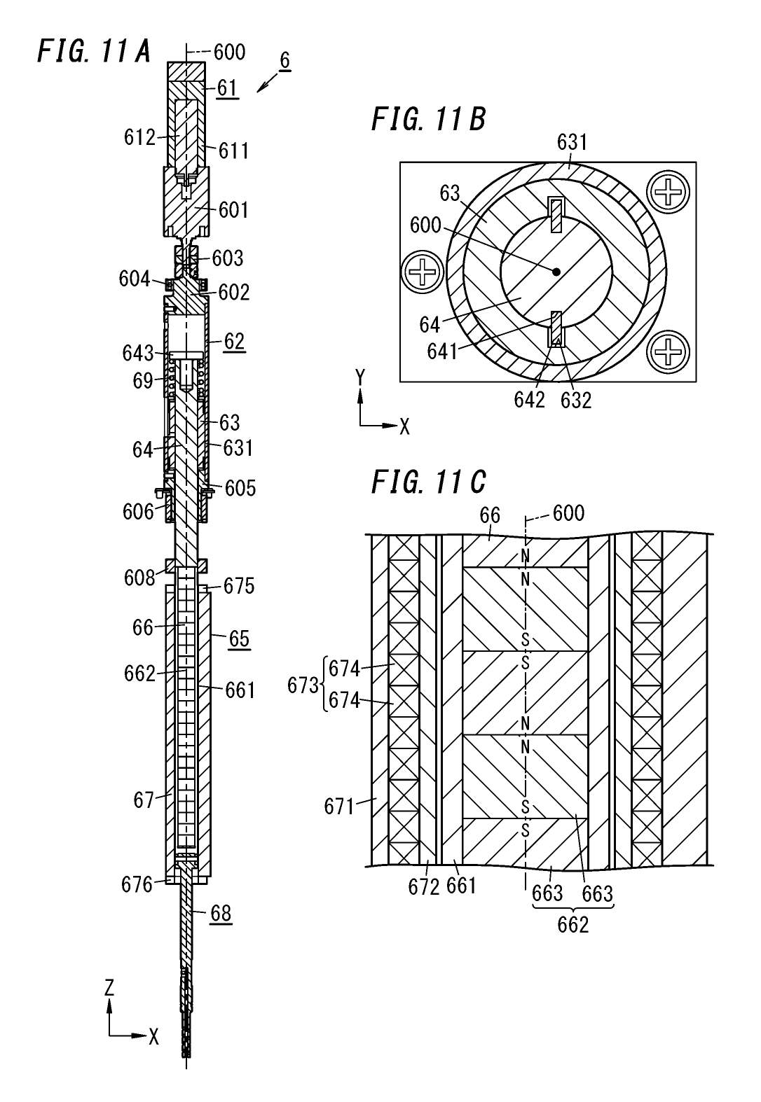

As shown in FIG. 11A, the actuator 6 includes a rotary motor 61, a spline member 62, a linear motor 65 and an output part 68.

The rotary motor 61 includes: a rotary mover 612 with a rotational axis 600 (i.e., an axis line) parallel to the Z-axis direction, the rotary mover 612 being configured to rotate around the rotational axis 600; and a rotary stator 611 that allows the rotary mover 612 to rotate around the rotational axis 600. As the rotary motor 61, used may be suitably a so-called Servo motor, Stepper motor or the like.

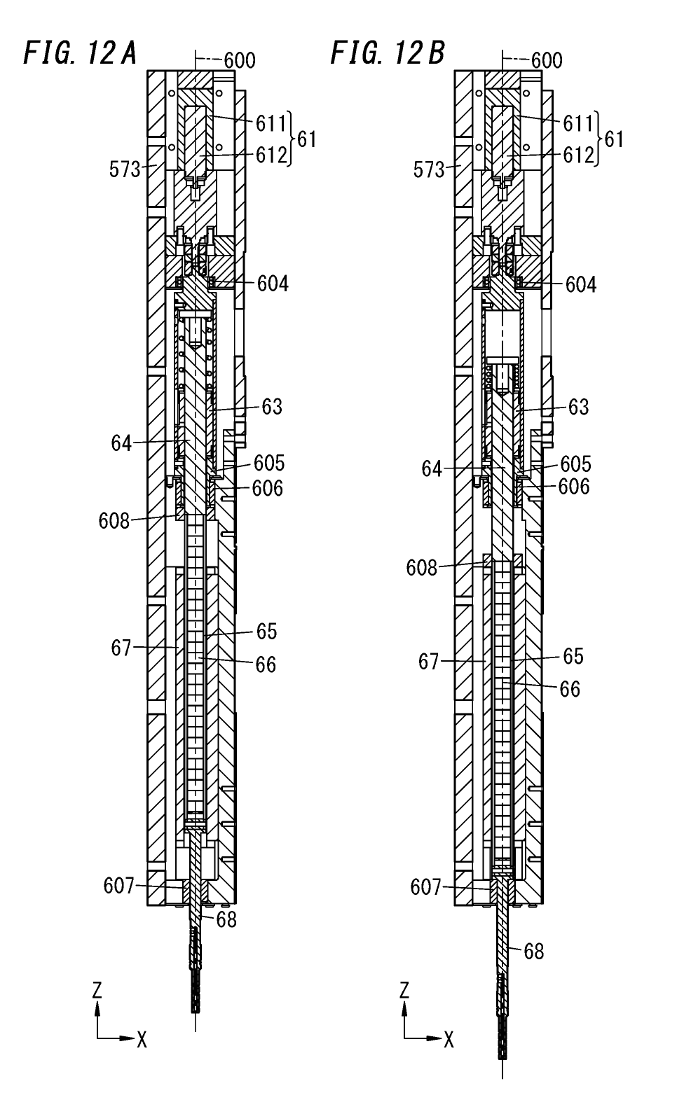

As shown in FIGS. 12A and 12B, the rotary stator 611 is fixed to the bracket 573 constituting the mount head frame 57. One end (upper end) of the rotary mover 612 in the direction of the rotational axis 600 is housed in the rotary stator 611. The other end (lower end) of the rotary mover 612 in the direction of the rotational axis 600 is disposed outside of the rotary stator 611. The rotary motor 61 is a so-called non-penetration type of rotary motor.

As shown in FIG. 11A, the rotary mover 612 is provided with a first coupling 601 an upper end of which is coupled to the lower end of the rotary mover 612. The first coupling 601 has an axis (axis line) that agrees with the rotational axis 600 of the rotary mover 612. A lower end of the first coupling 601 is coupled to an upper end of a second coupling 602 with a third coupling 603 interposed therebetween. The second coupling 602 has an axis (axis line) that agrees with the axis of the first coupling 601 (i.e., the rotational axis 600).

The spline member 62 includes a first member 63 and a second member 64. The first member 63 is configured to receive torque (rotation force) from the rotary mover 612 to rotate around the rotational axis 600. The second member 64 is disposed to overlap, in the radial direction, with a part of the first member 63 in the rotational axis 600. The second member 64 is configured to straightly move on the rotational axis 600, and receive torque from the first member 63 to rotate around the rotational axis 600.

In the present embodiment, the first member 63 is formed as a tubular member a longitudinal direction of which is in parallel to the direction of the rotational axis 600. The first member 63 has an outer peripheral surface that is fixed to an inner peripheral surface of an outer cylinder member 631, with the first member 63 and the outer cylinder member 631 being integrated with each other. The first member 63 has an axis (axis line) that agrees with the rotational axis 600.

A lower end of the second coupling 602 is coupled to an upper end of the outer cylinder member 631. The axis of the second coupling 602 agrees with an axis (axis line) of the outer cylinder member 631 (i.e., the rotational axis 600).

The second coupling 602 is provided with a first bearing 604 having an inner member and an outer member. The inner member of the first bearing 604 is fixed to an outer peripheral surface of the second coupling 602. The outer member of the first bearing 604 is fixed to the bracket 573 (refer to FIG. 12A). The second coupling 602 is accordingly rotatable around the rotational axis 600 while being supported by the bracket 573 through the first bearing 604.

The outer cylinder member 631 is provided with a fourth coupling 605 an upper end of which is coupled to a lower end of the outer cylinder member 631. The fourth coupling 605 has an axis (axis line) that agrees with the axis of the outer cylinder member 631 (the rotational axis 600).

The fourth coupling 605 is provided with a second bearing 606 having an inner member and an outer member. The inner member of the second bearing 606 is fixed to an outer peripheral surface of the fourth coupling 605. The outer member of the second bearing 606 is fixed to the bracket 573 (refer to FIG. 12A). The fourth coupling 605 is accordingly rotatable around the rotational axis 600 while being supported by the bracket 573 through the second bearing 606.

Weight of the second coupling 602, the outer cylinder member 631, the first member 63 and the fourth coupling 605 is therefore applied to the bracket 573 via the first and second bearings 604 and 606. In other words, the first member 63 is supported by the bracket 573.

The second member 64 has a long axis (longitudinal direction) which is in parallel to the direction of the rotational axis 600, and is formed as a shaft member to be inserted into an inside space of the first member 63. As shown in FIG. 11B, the first member 63 has a first key groove 632 formed in a part of an inner peripheral surface of the first member 63 in a circumferential direction around the rotational axis 600. The first key groove 632 is along the direction of the rotational axis 600. The first key groove 632 may be formed over the whole length of the first member 63 in the direction of the rotational axis 600, or in a part of the first member 63 in the direction of the rotational axis 600. The second member 64 has a second key groove 641 formed in a part of an outer peripheral surface of the second member 64 in a circumferential direction around the rotational axis 600. The second key groove 641 is along the direction of the rotational axis 600. The second key groove 641 may be formed over the whole length of the second member 64 in the direction of the rotational axis 600, or in a part of the second member 64 in the direction of the rotational axis 600. Into the second key groove 641, a key 642 is fitted to be secured. The key 642 has an edge protruded from the outer peripheral surface of the second member 64.

As shown in FIG. 11A, the second member 64 is inserted into the inside of the first member 63 along the direction of the rotational axis 600. In this state, the edge of the key 642 (protruded from the outer peripheral surface of the second member 64) is housed in the first key groove 632. In the Z-axis direction (direction of the rotational axis 600) the second key groove 641 has a size at least greater than that of the key 642. For this reason, the second member 64 is restricted from relatively rotating around the rotational axis 600 with respect to the first member 63. The second member 64 is movable straightly in the direction of the rotational axis 600 with respect to the first member 63.

The second member 64 is provided at an upper end thereof with a flange 643 fixed thereto. The flange 643 has a diameter around the rotational axis 600, the diameter being greater than that of the first member 63 around the rotational axis 600.

An upper end of a linear mover 66 (described later) is coupled to the lower end of the second member 64. A fifth coupling 608 is fitted into the lower end of the second member 64 and the upper end of the linear mover 66, thereby the second member 64 and the linear mover 66 being coupled with each other.

The linear motor 65 includes the linear mover 66 and a linear stator 67. The linear mover 66 is configured to receive torque from the second member 64 to rotate around the rotational axis 600. The linear stator 67 is configured to provide driving force along the direction of the rotational axis 600 to the linear mover 66.

As shown in FIG. 11C, the linear stator 67 includes: an outer cylinder 671 a longitudinal direction of which is in parallel to the direction of the rotational axis 600; and a winding core 672 formed as a tubular member. The winding core 672 is disposed inside of the outer cylinder 671, and has an axis (axis line), a direction of which is in parallel to the direction of the rotational axis 600. The winding core 672 is provided with a coil 673 (described later) wound around a surface of the winding core 672 so that the coil 673 is held by the winding core 672. The outer cylinder 671 and the winding core 672 are fixed to the bracket 573 (refer to FIG. 12A). The inside space of the winding core 672 servers as a path for the linear mover 66. The linear stator 67 further includes the coil 673. The coil 673 is constituted by a plurality of unit coils 674 wound around the winding core 672. As one example, three unit coils 674 (respectively corresponding to a U-phase, a V-phase and a W-phase) are defined as a set and a plurality of the sets are arranged in the Y-axis direction. The coil 673 and the winding core 672 are housed in the outer cylinder 671 with the coil 673 being wound around the winding core 672.

The linear mover 66 is formed as a shaft member to be inserted into an inside space of the linear stator 67. The linear mover 66 is disposed to penetrate the linear stator 67 in the direction of the rotational axis 600. The linear mover 66 includes an outer cylinder 661 a longitudinal direction of which is in parallel to the direction of the rotational axis 600. The outer cylinder 661 includes therein a permanent magnet 662, where magnetic force acts on between the permanent magnet 662 and the coil 673 while excitation current is allowed to flow through the coil 673. The permanent magnet 662 is fitted into the inside of the outer cylinder 661. The permanent magnet 662 is constituted by a plurality of unit permanent magnets 663 arranged in the direction of the rotational axis 600. In the plurality of unit permanent magnets 663, two unit permanent magnets 663 adjacent in the direction of the rotational axis 600 are arranged so that the poles of ends thereof facing each other are the same (the S poles, or the N poles).

As shown in FIG. 11A, the linear stator 67 is provided with a first guide part 675. The first guide part 675 is fixed to an upper end of the linear stator 67. The first guide part 675 guides the linear mover 66 so as to avoid the linear mover 66 from coming into contact with an inner surface of the linear stator 67. The linear stator 67 is further provided with a second guide part 676. The second guide part 676 is fixed to a lower end of the linear stator 67. The second guide part 676 guides the linear mover 66 so as to avoid the linear mover 66 from coming into contact with the inner surface of the linear stator 67. The linear mover 66 has an axis (axis line) that agrees with the rotational axis 600.

The linear mover 66 is configured to move, together with the second member 64, in the direction of the rotational axis 600. The flange 643 is provided at the upper end of the second member 64. As described above, the flange 643 has the diameter greater than that of the first member 63. Even when the second member 64 moves downward, the flange 643 comes into contact with the upper end of the first member 63. The second member 64 is therefore restricted from further moving downward from the position. As a result the second member 64 can be suppressed from falling from the first member 63.

The linear mover 66 moves in the direction of the rotational axis 600 with being integrated with the second member 64. Herein “the linear mover 66 being integrated with the second member 64” means that the linear mover 66 is fixed to the second member 64 not to move relatively with respect to the second member 64, and the linear mover 66 and the second member 64 are the same as each other in diameter. The linear mover 66 and the second member 64 may not be exactly the same as each other in diameter. Their diameters may slightly differ from each other to an extent such that they can be practically deemed to be the same.

The linear mover 66 and the second member 64 may be formed by the same member without having joints. Alternatively the linear mover 66 and the second member 64 may be respectively formed by members different from each other and in this case the members may be coupled with each other by welding, bonding, bolting or the like.

The actuator 6 further includes an elastic member 69 of applying force to the linear mover 66 upward (i.e., the positive direction of the Z-axis) in the rotational axis 600 of the linear mover 66. The elastic member 69 is a coil spring where a wire being wound around the rotational axis 600. The elastic member 69 is disposed between the upper end of the first member 63 and the flange 643 to be wound around the second member 64. As described above, the second member 64 can be suppressed by the flange 643 from falling from the first member 63. However, when the second member 64 and the linear mover 66 move downward by their own weight in occurrence of power failure and so on, the picking-up part 70 may come into contact with the substrate B1, the component P1 mounted on the substrate B1, and the like. To avoid such contact, the elastic member 69 is provided. That is, even when the second member 64 and the linear mover 66 move downward by their own weight, the elastic member 69 is compressed and the second member 64 and the linear mover 66 therefore receive the force upward from the elastic member 69 to be moved upward. For this reason, the picking-up part 70 can be prevented from coming into contact with the substrate B1, the component P1 mounted on the substrate B1 and the like, even when the second member 64 and the linear mover 66 move downward by their own weight in the power failure and so on.

The output part 68 is integrated with the linear mover 66. The second member 64, the linear mover 66 and the output part 68 with integrated constitute an output unit 680. The linear mover 66 and the output part 68 may be formed by members different from each other being integrally fixed. The output part 68 is driven by the rotary motor 61 and the linear motor 65.

As shown in FIG. 12A, the actuator 6 further includes a third guide part 607 to guide the output part 68 moving along the rotational axis 600. The third guide part 607 is fixed to the bracket 573.

In the First Embodiment explained above, the rotary motor 61, the spline member 62, the linear motor 65 and the output part 68 are arranged on the rotational axis 600. That is, it is possible to reduce a size in a cross section orthogonal to the rotational axis 600, of the actuator 6.

As shown in FIG. 10B, in case a plurality of the actuators 6 (two actuators in the drawings) are arranged, it is therefore possible to set a pitch 71 between the actuators 6 to a comparatively small pitch (e.g., 12 mm). As shown in FIGS. 1, 2A and 2B, feeder cassettes 154 may be often arranged at a pitch of 12mm in the X-axis direction. In this case, the pitch 71 between the actuators 6 (or between the picking-up parts 70) can be made to correspond to the pitch between the feeder cassettes 154. It is also possible to more increase the number of the actuators 6 and the picking-up parts 70 to be arranged in such a small space.

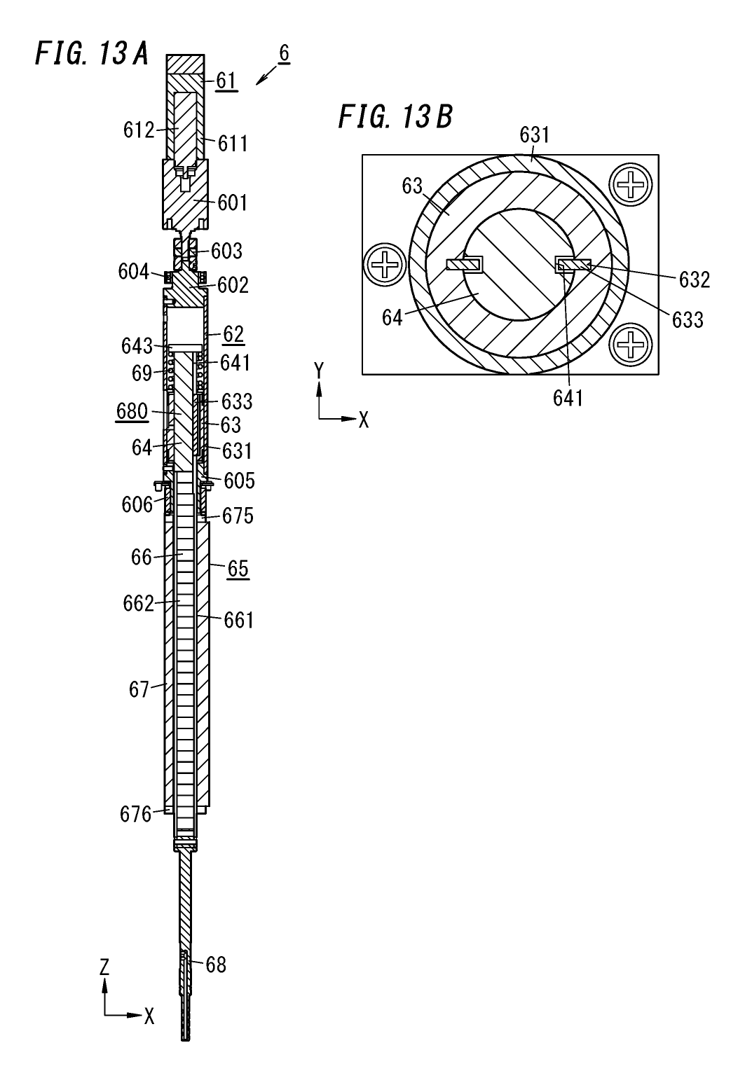

Next a Second Embodiment will be explained with reference to FIGS. 13A to 15B. Note that a mounting apparatus 1 of the Second Embodiment has mostly elements similar to those of the First Embodiment. Therefore, explanations of the elements similar to those of the First Embodiment will be appropriately omitted.

In the First Embodiment, the linear mover 66 and the second member 64 are arranged in the direction of the rotational axis 600 (i.e., the Z-axis direction) and the fifth coupling 608 is fitted into the lower end of the second member 64 and the upper end of the linear mover 66. In this manner the second member 64 and the linear mover 66 are coupled with each other.

On the other hand, in the Second Embodiment, a linear mover 66 and a second member 64 are integrated with each other while they are arranged in a direction of a rotational axis 600. Herein “the linear mover 66 and the second member 64 are integrated with each other” means that the linear mover 66 is fixed to the second member 64 not to move relatively with respect to the second member 64, and the linear mover 66 and the second member 64 are the same as each other in diameter. The linear mover 66 and the second member 64 may not be exactly the same as each other in diameter. Their diameters may slightly differ from each other to an extent such that they can be practically deemed to be the same.

The linear mover 66 and the second member 64 may be formed by the same member without having joints. Alternatively the linear mover 66 and the second member 64 may be respectively formed by members different from each other and in this case the members may be coupled with each other by welding, bonding, bolting or the like.

The Second Embodiment is similar to the First Embodiment in that an output part 68 is integrated with the linear mover 66. Accordingly the second member 64, the linear mover 66 and the output part 68 with integrated constitute an output unit 680.

Also in the Second Embodiment, a key 633 is fitted into a first key groove 632 of a first member 63, as shown in FIG. 13B. The key 633 is inserted into a second key groove 641 of a second member 64, thereby the second member 64 being guided to move in the direction of the rotational axis 600.

The Second Embodiment does not need the fifth coupling 608 of the First Embodiment provided over the second member 64 from the linear mover 66. The weight of the output unit 680 can be therefore reduced by the weight of the fifth coupling 608.

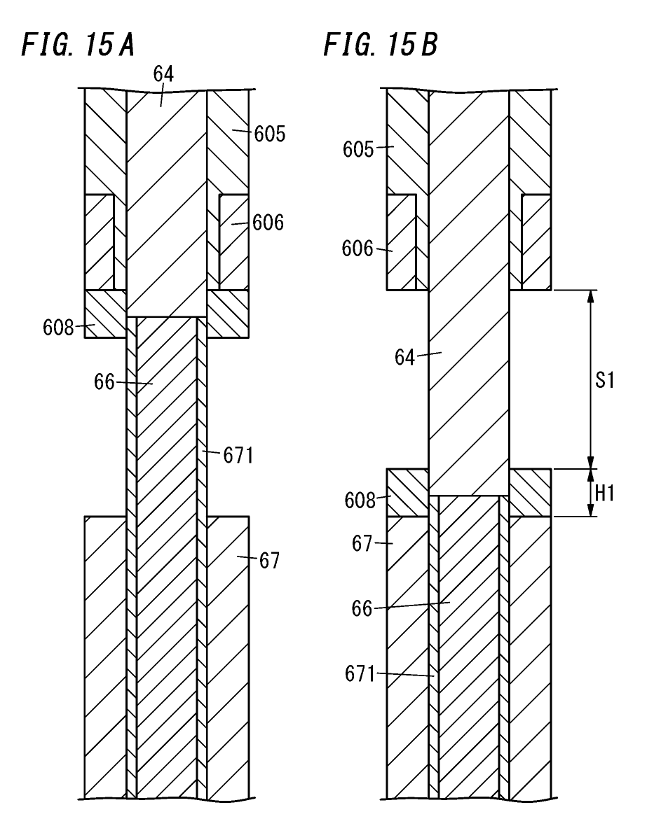

As shown in FIGS. 12A and 15A, in the First Embodiment, the fifth coupling 608 with the lower end of the second member 64 being fitted thereto is in contact with a lower end surface of the fourth coupling 605. The lower end of the second member 64 is accordingly restricted from entering the fourth coupling 605. Also as shown in FIGS. 12B and 15B, the fifth coupling 608 with the upper end of the linear mover 66 being fitted thereto is in contact with an upper end surface of the linear stator 67. The upper end of the linear mover 66 is accordingly restricted from entering the linear stator 67. Thus, in the direction of the rotational axis 600 (up-down direction), parts of the linear mover 66 and the second member 64, where the fifth coupling 608 is positioned, can enter neither the fourth coupling 605 nor the linear stator 67. As shown in FIG. 15B, in the direction of the rotational axis 600, the fourth coupling 605 and the linear stator 67 are needed to be disposed at an interval that is at least equal to or more than a length obtained by adding a length H1 of the fifth coupling 608 to a stroke length Si of the output unit 680.

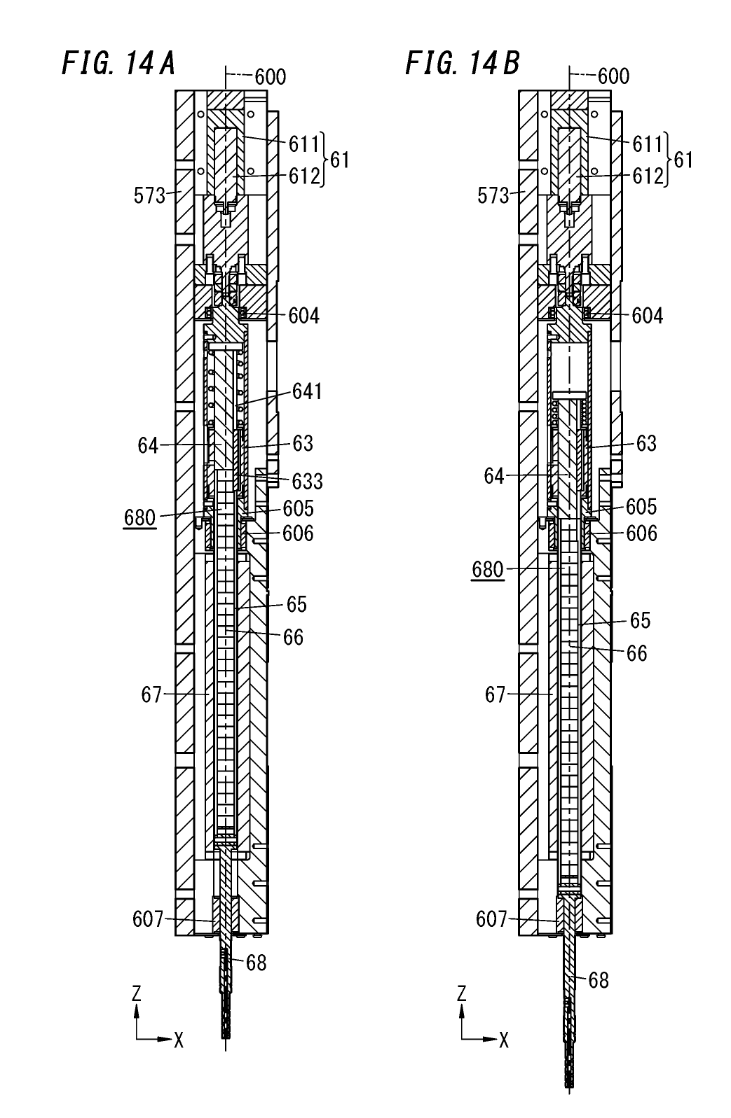

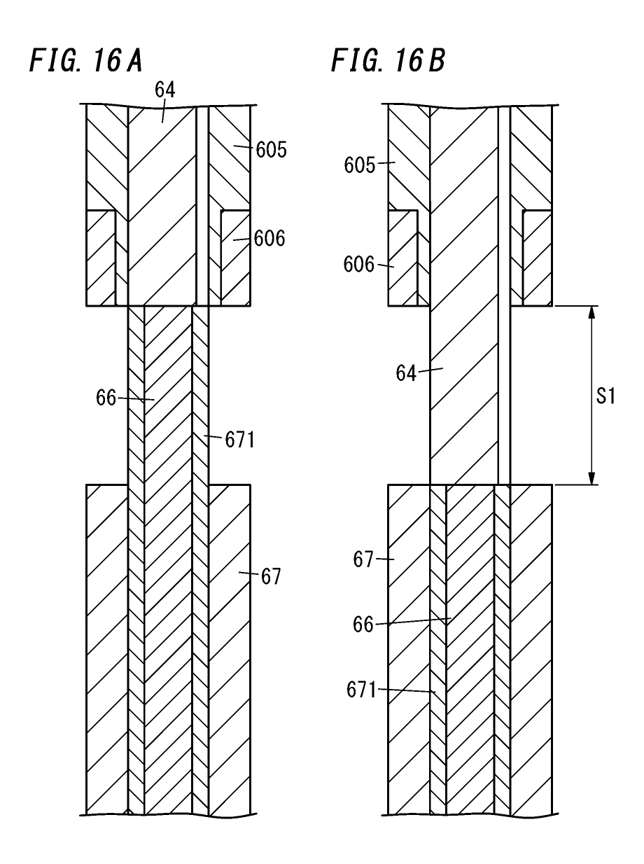

On the other hand, in the Second Embodiment, the fifth coupling 608 is not provided as shown in FIGS. 13A, 14A and 14B. For this reason when the output unit 680 has risen as shown in FIG. 16A, the lower end of the second member 64 can enter the fourth coupling 605. Also when the output unit 680 has fallen as shown in FIG. 16B, the upper end of the linear mover 66 can enter the linear stator 67. In the direction of the rotational axis 600, the interval between the fourth coupling 605 and the linear stator 67 corresponds to the stroke length Si of the output unit 680. Accordingly, in the direction of the rotational axis 600, the whole length of the linear mover 66 and the second member 64 can be more shortened by the length H1 of the fifth coupling 608, compared with the First Embodiment.

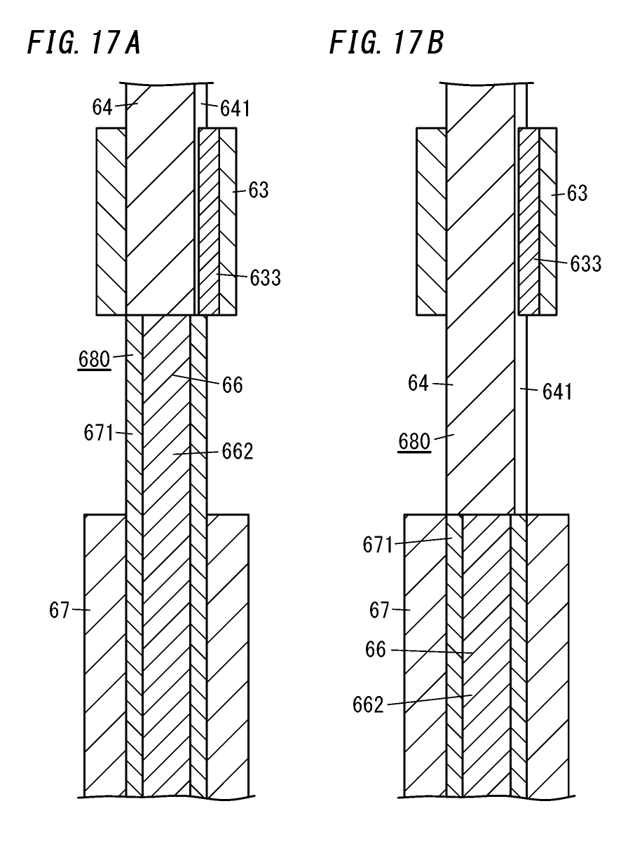

Next a Third Embodiment will be explained with reference to FIGS. 17A and 17B. Note that a mounting apparatus 1 of the Third Embodiment has mostly elements similar to those of the Second Embodiment. Therefore, explanations of the elements similar to those of the Second Embodiment will be appropriately omitted.

In the Second Embodiment, the fourth coupling 605 is disposed between the first member 63 of the spline member 62 and the linear stator 67. On the other hand, in the Third Embodiment, no coupling is disposed between a first member 63 and a linear stator 67.

Regarding an output unit 680, a second key groove 641 is provided from a proximity of an upper end of a second member 64 to a lower end thereof, and a permanent magnet 662 is disposed from a proximity of a lower end of a linear mover 66 to an upper end thereof.

As shown in FIG. 17A, when the output unit 680 has risen to an upper limit position in a movable range, a lower edge of the second member 64 becomes, in the Z-axis direction, at the same position as a lower edge of the first member 63.

Whereas, as shown in FIG. 17B when the output unit 680 has fallen to a lower limit position in the movable range, an upper edge of the linear mover 66 (the lower edge of the second member 64) becomes, in the Z-axis direction, at the same position as an upper edge of the linear stator 67.

In this case, the first member 63 and the linear stator 67 are needed to be disposed, in a direction of a rotational axis 600, at an interval that is at least equal to or more than a stroke length Si of the output unit 680. In the Third Embodiment, in the direction of the rotational axis 600, the interval between the first member 63 and the linear stator 67 can be more shortened by a length obtained by adding a length H1 of a fifth coupling 608 to a length of a fourth coupling 605, compared with the Second Embodiment.

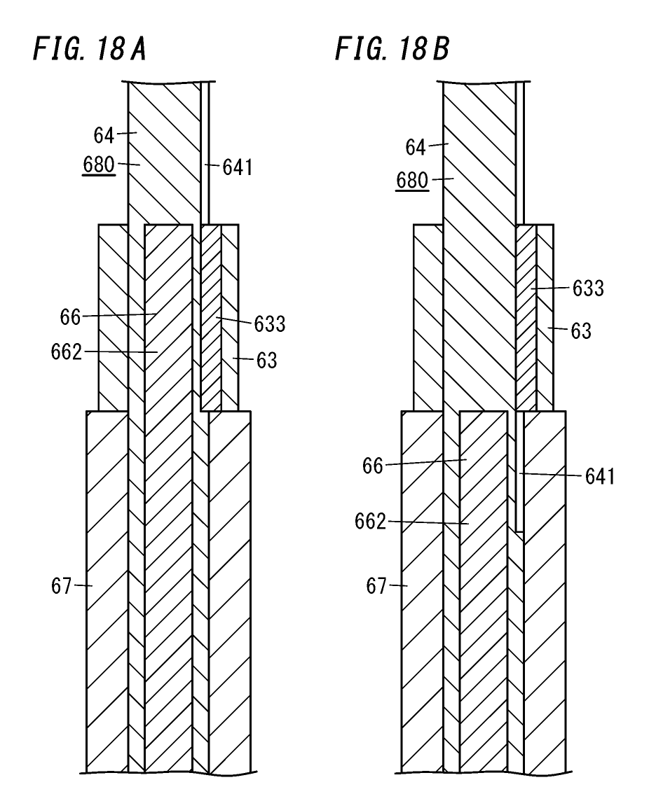

Next a Fourth Embodiment will be explained with reference to FIGS. 18A and 18B. Note that a mounting apparatus 1 of the Fourth Embodiment has mostly elements similar to those of the Third Embodiment. Therefore, explanations of the elements similar to those of the Third Embodiment will be appropriately omitted.

In the Third Embodiment, the interval between the first member 63 and the linear stator 67 in the direction of the rotational axis 600 corresponds to the stroke length Si of the output unit 680. In the Fourth Embodiment, an interval between a first member 63 and a linear stator 67 in a direction of a rotational axis 600 is zero.

As shown in FIG. 18A a linear mover 66 is provided with a permanent magnet 662 extending from an inside of the linear mover 66 to a position of a second key groove 641 of a second member 64 in the direction of the rotational axis 600. In the direction of the rotational axis 600 of the linear mover 66 and the second member 64, a part of the permanent magnet 662, overlapping with the second key groove 641 in FIG. 18B, can enter either the linear stator 67 or the first member 63. The part of the permanent magnet 662 (overlapping with the second key groove 641 in FIG. 18B) is set to have, in the direction of the rotational axis 600, a length equal to or greater than that of a stroke length Si of an output unit 680. Accordingly the interval between the first member 63 and the linear stator 67 in the direction of the rotational axis 600 can be zero.

Therefore, the actuator 6 can be shortened in length in the direction of the rotational axis 600.

Next variations of the First to Fourth Embodiments will be explained.

The Y-axis linear motor 31 is not limited to the cylindrical linear motor. That is, the Y-axis linear motor 31 may be a tubular linear motor with a shape other than a cylindrical (round) shape. Also the Y-axis linear motor 31 is not limited to the tubular linear motor. The Y-axis linear motor 31 may be for example a so-called “flat type of linear motor”.

The refrigerant to be made to pass through the inside space 34 of the winding core 322 is preferably water (e.g., cooling water) but may be liquid other than the water.

The Y-axis linear guide 37 is not limited to the LM guide (registered trademark) as described above, as long as it is a mechanism that guides the Y-axis linear motor mover 35 moving on a straight line.

In the First to Fourth Embodiments the Y-axis moving device 3 includes the Y-axis linear motor 31 and the Y-axis linear guide 37, but may not include the Y-axis linear guide 37. Also the Y-axis moving device 3 may further include another element(s) in addition to the Y-axis linear motor 31 and the Y-axis linear guide 37.

The X-axis linear motor 41 is not limited to the cylindrical linear motor. That is, the X-axis linear motor 41 may be a tubular linear motor with a shape other than a cylindrical (round) shape. Also the X-axis linear motor 41 is not limited to the tubular linear motor. The X-axis linear motor 41 may be for example a so-called “flat type of linear motor”.

The refrigerant to be made to pass through the inside space 44 of the winding core 422 is preferably water but may be liquid other than the water.

The X-axis linear guide 47 is not limited to the LM guide (registered trademark) as described above, as long as it is a mechanism that guides the X-axis linear motor mover 45 moving on a straight line.

In the First Embodiment the X-axis moving device 4 includes the X-axis linear motor 41 and the X-axis linear guide 47, but may not include the X-axis linear guide 47. Also the X-axis moving device 4 may further include another element(s) in addition to the X-axis linear motor 41 and the X-axis linear guide 47.

The rotary motor 61 is not limited in particular, but may be a motor other than the so-called Servo motor or Stepper motor.

In the First to Fourth Embodiments the rotary mover 612 of the rotary motor 61 is coupled to the first member 63 of the spline member 62 through the first coupling 601, the second coupling 602 and the third coupling 603. However, the rotary mover 612 of the rotary motor 61 may be coupled to the first member 63 through only the first coupling 601 or only the second coupling 602. Alternatively the rotary mover 612 of the rotary motor 61 may be directly coupled to the first member 63 without such the couplings.

The spline member 62 may be a so-called “ball spline”.

Any one of the Y-axis linear motor 31 or the X-axis linear motor 41 may be not a linear motor but a mechanism having a rotary motor and a ball screw.

As apparent from the above-mentioned First to Fourth embodiments and the variations, an actuator (6) of a first aspect includes a rotary motor (61), a spline member (62), a linear motor (65), and an output part (68). The rotary motor (61) includes a rotary mover (612) with a rotational axis (600) (axis line), the rotary mover (612) being configured to rotate around the rotational axis (600). The spline member (62) includes: a first member (63) that receives torque from the rotary mover (612) to rotate around the rotational axis (600); and a second member (64) that reciprocates on the rotational axis (600), and receives torque from the first member (63) to rotate around the rotational axis (600). The linear motor (65) includes: a linear mover (66) that receives torque from the second member (64) to rotate around the rotational axis (600); and a linear stator (67) that provides driving force along a direction of the rotational axis (600) to the linear mover (66). The output part (68) is to be driven by the rotary motor (61) and the linear motor (65), the output part (68) being disposed at an end of the linear mover (66). The linear mover (66) penetrates the linear stator (67) in the direction of the rotational axis (600). The linear mover (66) is configured to rotate around the rotational axis (600) with respect to the linear stator (67).

According to the first aspect, since the rotary motor (61), the spline member (62) and the linear motor (65) are arranged on the rotational axis (600), it is possible to reduce a size in a cross section orthogonal to a direction of the rotational axis (600), of the actuator (6).

A second aspect can be realized in combination with the first aspect. In the second aspect, the rotary motor (61) further includes a rotary stator (611) that allows the rotary mover (612) to rotate around the rotational axis (600). The rotary stator (611) houses therein one end of the rotary mover (612) in the direction of the rotational axis (600), another end of the rotary mover (612) in the direction of the rotational axis (600) being disposed outside of the rotary stator (611).

According to the second aspect, it is possible to use as the rotary motor (61) a so-called non-penetration type of rotary motor.

A third aspect can be realized in combination with the first aspect or the second aspect. In the third aspect, the linear stator (67) includes a permanent magnet (677), and the linear mover (66) includes a coil (665) that makes magnetic force act on the permanent magnet (677).

According to the third aspect, it is possible to more reduce at least one of the number of the permanent magnets (677) to be used and the size thereof, compared with a case the linear mover (66) includes a permanent magnet.

A fourth aspect can be realized in combination with the first aspect or the second aspect.

In the fourth aspect, the linear mover (66) includes a permanent magnet (662), and the linear stator (67) includes a coil (673) that makes magnetic force act on the permanent magnet (662).

According to the fourth aspect, it is possible to easily shorten the length of the actuator (6) in the direction of the rotational axis (600).

A fifth aspect can be realized in combination with any one of the first to fourth aspects. In the fifth aspect, the actuator (6) further includes an elastic member (69) of applying force to the linear mover (66) from one end of the linear mover (66) toward another end of the linear mover (66) in the direction of the rotational axis (600).

According to the fifth aspect, for example, a picking-up part (70) can be prevented from coming into contact with the substrate (B1), the component (P1) mounted on the substrate (B1) and the like, even when the second member (64) and the linear mover (66) move downward by their own weight.

A sixth aspect can be realized in combination with any one of the first to fifth aspects. In the sixth aspect, a mount head unit (56) includes: the actuator (6); and a picking-up part (70) that picks up a first object to be mounted on a second object, the picking-up part (70) being fixed to the output part (68) of the actuator (6).

According to the sixth aspect, since the rotary motor (61), the spline member (62), the linear motor (65) and the output part (68) are arranged on the rotational axis (600), it is possible to reduce a size in a cross section orthogonal to a direction of the rotational axis (600), of the actuator (6).

A seventh aspect can be realized in combination with the sixth aspect. In the seventh aspect, a mounting apparatus (1) includes: the mount head unit (56); and a holding device that holds the second object.

According to the seventh aspect, since the rotary motor (61), the spline member (62), the linear motor (65) and the output part (68) are arranged on the rotational axis (600), it is possible to reduce a size in a cross section orthogonal to a direction of the rotational axis (600), of the actuator (6).

As apparent from the above-mentioned First, Third and Fourth embodiments and the variations, an actuator (6) of an eighth aspect includes a rotary motor (61) including a rotary mover (612), a spline member (62), a linear motor (65), and an output part (68). The spline member (62) includes: a first member (63) that receives torque from the rotary mover (612) to rotate around a rotational axis (600); and a second member (64) that reciprocates on the rotational axis (600), and receives torque from the first member (63) to rotate around the rotational axis (600). The linear motor (65) includes: a linear mover (66) that receives torque from the second member (64) to rotate around the rotational axis (600); and a linear stator (67) that provides driving force along a direction of the rotational axis (600) to the linear mover (66). The output part (68) is to be driven by the rotary motor (61) and the linear motor (65), the output part (68) being disposed at an end of the linear mover (66). The linear mover (66) includes a permanent magnet (662), and the linear stator (67) includes a coil that makes magnetic force act on the permanent magnet (662). The linear mover (66) penetrates the linear stator (67) in the direction of the rotational axis (600) and is configured to rotate around the rotational axis (600) relatively with respect to the linear stator (67). The linear mover (66) and the second member (64) are arranged in the direction of the rotational axis (600), and the linear mover (66) and the second member (64) are integrated.

According to the eighth aspect, the coupling is unnecessary and the weight of the actuator (6) can be therefore reduced.

A ninth aspect can be realized in combination with the eighth aspect. In the ninth aspect, the first member (63) has a first key groove (632) into which a key (633) is fitted. The second member (64) has a second key groove (641) into which the key (633) is inserted. In the direction of the rotational axis (600), the permanent magnet (662) is disposed to positionally overlap with a part or an entire of the second key groove (641).

According to the ninth aspect, in the direction of the rotational axis (600) of the linear mover (66) and the second member (64), a part of the permanent magnet (662), overlapping with the second key groove (641) in FIG. 18B, can enter either the linear stator (67) or the first member (63). Therefore, the actuator (6) can be shortened in length in the direction of the rotational axis (600).

A tenth aspect can be realized in combination with the eighth aspect or the ninth aspect. In the tenth aspect, the linear mover (66) is a non-magnetic body.

According to the tenth aspect, the linear mover (66) magnetized can be suppressed from entering the first member (63) of the spline member (62).

An eleventh aspect can be realized in combination with any one of the eighth to tenth aspects. In the eleventh aspect, the actuator (6) further includes a third guide part (607) of guiding the linear mover (66) or the output part (68) moving along the rotational axis (600).

According to the eleventh aspect, the magnetic flux from the linear mover (66) or the linear stator 67 can be prevented from acting on the linear mover (66) itself and design of a magnetic circuit can be therefore facilitated.

A twelfth aspect can be realized in combination with any one of the eighth to eleventh aspects. In the twelfth aspect, a mount head unit (56) includes: the actuator (6); and a picking-up part (70) that picks up a first object to be mounted on a second object, the picking-up part (70) being fixed to the output part (68) of the actuator (6).

According to the twelfth aspect, the coupling is unnecessary for the mount head unit (56) and the weight of the actuator (6) can be therefore reduced.

A thirteenth aspect can be realized in combination with the twelfth aspect. In the thirteenth aspect, a mounting apparatus (1) includes: the mount head unit (56); and a holding device that holds the second object.

According to the thirteenth aspect, the coupling is unnecessary for the mounting apparatus (1) and the weight of the actuator (6) can be therefore reduced.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. An actuator, comprising:
a rotary motor including a rotary mover with a rotational axis, the rotary mover being configured to rotate around the rotational axis;
a spline member including
a first member that receives torque from the rotary mover to rotate around the rotational axis, and
a second member that reciprocates on the rotational axis, and receives torque from the first member to rotate around the rotational axis;
a linear motor including
a linear mover that receives torque from the second member to rotate around the rotational axis, and
a linear stator that provides driving force along a direction of the rotational axis to the linear mover; and
an output part to be driven by the rotary motor and the linear motor, the output part being disposed at an end of the linear mover, the linear mover penetrating the linear stator in the direction of the rotational axis, and the linear mover being configured to rotate around the rotational axis with respect to the linear stator.

2. The actuator of claim 1, wherein
the rotary motor further includes a rotary stator that allows the rotary mover to rotate around the rotational axis, and
the rotary stator houses therein one end of the rotary mover in the direction of the rotational axis, another end of the rotary mover in the direction of the rotational axis being disposed outside of the rotary stator.

3. The actuator of claim 1, wherein
the linear stator includes a permanent magnet, and
the linear mover includes a coil that makes magnetic force act on the permanent magnet.

4. The actuator of claim 2, wherein
the linear stator includes a permanent magnet, and
the linear mover includes a coil that makes magnetic force act on the permanent magnet.

5. The actuator of claim 1, wherein
the linear mover includes a permanent magnet, and
the linear stator includes a coil that makes magnetic force act on the permanent magnet.

6. The actuator of claim 2, wherein
the linear mover includes a permanent magnet, and
the linear stator includes a coil that makes magnetic force act on the permanent magnet.

7. The actuator of claim 1, further comprising an elastic member of applying force to the linear mover from one end of the linear mover toward another end of the linear mover in the direction of the rotational axis.

8. The actuator of claim 2, further comprising an elastic member of applying force to the linear mover from one end of the linear mover toward another end of the linear mover in the direction of the rotational axis.

9. The actuator of claim 3, further comprising an elastic member of applying force to the linear mover from one end of the linear mover toward another end of the linear mover in the direction of the rotational axis.

10. The actuator of claim 5, further comprising an elastic member of applying force to the linear mover from one end of the linear mover toward another end of the linear mover in the direction of the rotational axis.

11. The actuator of claim 5, wherein
the linear mover and the second member are arranged in the direction of the rotational axis, and
the linear mover and the second member are integrated.

12. The actuator of claim 11, wherein
the first member has a first key groove into which a key is fitted,
the second member has a second key groove into which the key is inserted, and
in the direction of the rotational axis, the permanent magnet is disposed to positionally overlap with a part or an entire of the second key groove.

13. The actuator of claim 11, wherein
the linear mover is a non-magnetic body.

14. The actuator of claim 12, wherein
the linear mover is a non-magnetic body.

15. The actuator of claim 11, further comprising a guide part of guiding the linear mover or the output part moving along the rotational axis.

16. The actuator of claim 12, further comprising a guide part of guiding the linear mover or the output part moving along the rotational axis.

17. The actuator of claim 13, further comprising a guide part of guiding the linear mover or the output part moving along the rotational axis.

18. A mount head unit, comprising:
the actuator of claim 1; and
a picking-up part that picks up a first object to be mounted on a second object, the picking-up part being fixed to the output part of the actuator.

19. A mounting apparatus, comprising:
the mount head unit of claim 18; and
a holding device that holds the second object.

20. A driving method of an actuator,
the actuator comprising:
a rotary motor including a rotary mover with a rotational axis, the rotary mover being configured to rotate around the rotational axis;
a spline member including
a first member that receives torque from the rotary mover to rotate around the rotational axis, and
a second member that reciprocates on the rotational axis, and receives torque from the first member to rotate around the rotational axis;
a linear motor including
a linear mover that receives torque from the second member to rotate around the rotational axis, and
a linear stator that provides driving force along a direction of the rotational axis to the linear mover; and
an output part to be driven by the rotary motor and the linear motor, the output part being disposed at an end of the linear mover,
the driving method comprising
reciprocating, along the direction of the rotational axis, the linear mover penetrating the linear stator in the direction of the rotational axis, and
rotating the linear mover around the rotational axis with respect to the linear stator.
